(19) United States
(12) Patent Application Publication
(10) Pub. No.: US 2024/0403983 A1
(43) Pub. Date: Dec. 5, 2024

(54) ONLINE DEBATE PLATFORM AND METHOD

(71) Applicant: VURBIL, INC., Denver, CO (US)

(72) Inventor: ERIK MONROE UNDERWOOD, Denver, CO (US)

(21) Appl. No.: 18/801,351

(22) Filed: Aug. 12, 2024

Related U.S. Application Data
(63) Continuation-in-part of application No. 17/330,142, filed on May 25, 2021.
(60) Provisional application No. 63/532,004, filed on Aug. 10, 2023.

(51) Int. Cl. G06Q 50/18

(52) U.S. Cl. CPC G06Q 50/182; G06Q 2230/00

(57) ABSTRACT

The present invention comprises an online debate platform including video debate web and mobile application embodiments. The online debate platform provides a controlled setting for participants to have their debates viewed, voted on, and subsequently ranked by other users of the platform. The online debate platform further incorporates a unique AI monitoring system that updates debate “winners,” flags offensive content, and moderates each debate on the platform in real time. The online debate platform of the present invention provides a space for individuals to debate subjects in a uniformed structure and have real-time results from active user viewership. In embodiments, the online debate platform further incorporates video commenting, including live video comments, and customizable advertising functionality with advertisement previews.

### CROSS-REFERENCE TO RELATED APPLICATIONS

This application is a continuation-in-part application of co-pending U.S. patent application Ser. No. 17/330,142, filed May 25, 2021. This application further claims priority pursuant to 35 U.S.C. 119 (e) to co-pending U.S. Provisional Patent Application Ser. No. 63/532,004, filed Aug. 10, 2023. The entire disclosures of the aforementioned applications are incorporated herein by reference.

### FIELD OF THE INVENTION

The present invention relates generally to the field of online debate platforms. More specifically, the present invention is concerned with a system and method for facilitating and monitoring online debates using artificial intelligence (“AI”).

### BACKGROUND

Social media platforms have been around for more than 20 years, and in that time, the ability for users to post thoughts, ideas, and other media publicly or privately with friends remains largely the same and familiar across current social media platforms. By posting on currently available social media platforms, a user can engage in discussions with other users, and the premise of debating your opinions and viewpoints is commonplace. Unfortunately, current platforms are not designed for civil debates and do not monitor hostile comments or obscene language unless flagged by a user. Oftentimes, people with differing opinions talk at each other rather than talk with one another on social media platforms. Thus, current social media platforms commonly lead to online environments without respect between differing viewpoints and without a civil environment where both or all sides can be heard through technology and innovation. Such negative online environments draw considerable amounts of judgment and frustration from users and prospective users today. Accordingly, it would be beneficial to have a social media platform which provides users with a safe, secure, and designated outlet for debating every point of view.

In general, the current consensus of social media platforms today is that they no longer serve as a place to bring people together. All current platforms are plagued with “cancel culture” and rampant bullying protected by little to no guardrails. Accordingly, it would be beneficial to have an online platform with unique technology equipped for strict, user-agreed upon rules to govern a civil environment.

Heretofore there has not been available an online social media platform with the advantages and features of the present invention.

### SUMMARY OF THE INVENTION

The present online debate platform is designed to give a platform for people of all beliefs, walks of life, and points of view and to provide a common place to debate a wide range of topics. With the troubles of today, having a place for people to gather, debate, learn, and grow is greatly needed.

The present online debate platform provides wide-ranging services to. In an exemplary embodiment, a social media platform of the present invention combines elements of news and on-demand video debates governed by an artificial intelligence (“AI”) monitoring system. In an embodiment, the present platform accommodates and encourages input from the public to cultivate further discussions, debate topics, and entertainment.

Within a controlled setting created and curated by a support team, and a strict set of guidelines agreed to by each user, the present invention creates a place of honest debate and growth of ideas. For example, as set by the guidelines, in an exemplary embodiment, obscene language will not be permissible on the platform such as but not limited to language that is derogatory or hateful. As further discussed below, the present online debate platform's novel AI monitoring system can detect and correct such instances in real time.

By creating a safe and secure place for different minds to debate their points of view, the online debate platform application fills the void left by current social media platforms that currently do not provide a secure and organized space to do so.

In an exemplary embodiment, a user, once paired with an opponent user, is given a predetermined amount of time to present arguments for an audience. An AI monitoring system will utilize an electronic “coin flip” function to determine which user will speak first. Subsequently, the user who is not selected to speak first will get to speak last for closing remarks to keep the debates balanced and impartial. Once the debate has concluded, the AI monitor instantly tabulates the viewer votes on the “winning” argument. However, in embodiments, the winner of public debate(s) may change over time based upon future viewings and corresponding voting at a later time. In an embodiment, all video debates, public and private, are available to view on demand 24/7.

In an exemplary embodiment, the present novel platform can be utilized via different mediums such as but not limited to smartphones, tablets, laptop computers, desktop computers, and smart TVs.

Embodiments of the online debate platform, as previously stated, provide various additional services and features outside of head-to-head video debates. As such, in embodiments, the online platform provides daily video news alerts and a formatted weekly show. In an exemplary embodiment, the user is notified (unless such user opts-out and/or selects only specific topics) multiple times a day of current 40-second news blasts. In alternative embodiments, the duration of the news blasts are 10 seconds, 15 seconds, 20 seconds, 30 seconds, 45 seconds, 1 minute, 1 minute 15 seconds, 1 minute 30 seconds, 1 minute 45 seconds, 2 minutes, 2 minutes 15 seconds, 2 minutes 30 seconds, 2 minutes 45 seconds, 3 minutes, about 10 seconds, about 15 seconds, about 20 seconds, about 30 seconds, about 40 seconds, about 45 seconds, about 1 minute, about 1 minute and 15 seconds, about 1 minute and 30 seconds, about 1 minute and 45 seconds, about 2 minutes, about 2 minutes 15 seconds, about 2 minutes 30 seconds, about 2 minutes 45 seconds, or about 3 minutes.

In embodiments, a weekly 30-minute video news content show hosted by a panel discussing wide-ranging trending topics from all over the world is available to user(s) of the present platform. In alternative embodiments, the duration of the show is 10 minutes, 15 minutes, 20 minutes, 25 minutes, 35 minutes, 40 minutes, 45 minutes, 50 minutes, 55 minutes, 1 hour, 1 hour and 15 minutes, 1 hour and 30 minutes, 1 hour and 45 minutes, 2 hours, about 10 minutes, about 15 minutes, about 20 minutes, about 25 minutes, about 30 minutes, about 35 minutes, about 40 minutes, about 45 minutes, about 50 minutes, about 55 minutes, about 1 hour, about 1 hour and 15 minutes, about 1 hour and 30 minutes, about 1 hour and 45 minutes, or about 2 hours. In embodiments, the news content show airs daily, twice daily, three times daily, every two weeks, monthly, quarterly, about weekly, about daily, about twice daily, about three times daily, about every two weeks, about monthly, or about quarterly. In addition to the video debates, in embodiments, the video news blast(s) and online show are viewable on electronic devices.

In an exemplary embodiment, the present platform provides multiple options for participation accessible across all major electronic devices including but not limited to smartphones, tablets, laptops, desktop computers, etc. The present online debate platform allows users from every walk of life an opportunity to utilize the platform's many debate videos, newscasts, and other video content. Video camera compatibility is only required to utilize the platform to participate in active or future video debate(s) or video comments. Otherwise, a user can still utilize the platform as a source of entertainment, content, news briefings, etc. without a video camera. With a single click, a user can view daily news blasts, watch current or previous episodes of an online show, watch current or previous public debates, comment or vote on public debates, and actively participate in active or pending debates as one of the participants.

Through the platform's strict set of guidelines, the present platform allows the users to know with confidence that their viewpoints will be respected if not always agreed with.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a schematic diagram showing data flow from an account via a dashboard of an online platform of the present invention.

FIG. 2 is a schematic diagram showing data flow of live streaming and video on demand (VOD) broadcasting of the present invention.

FIG. 3 is a schematic diagram showing data flow for a viewer interaction on live or previously recorded debates and videos.

FIG. 4 is a schematic diagram illustrating how a user can create a future debate and/or instant debate for a topic the user wants to discuss which is not already prompted or available.

FIG. 5 is a schematic diagram showing an AI monitoring system of the online debate platform configured to flag obscene language and notify user(s) and platform administrator(s) thereof.

FIGS. 6A and 6B make up a flow chart illustrating the flow of each debate and a virtual coin toss feature utilized within the platform.

FIG. 7 shows an embodiment of a user interface dashboard of the present invention viewable on a mobile device.

FIG. 8 shows an embodiment of a user interface dashboard of the present invention viewable via a website.

FIG. 9 shows an embodiment of how the user can create a debate for a future and/or instant debate via the user interface on the website.

FIG. 10 shows an embodiment of how the user can create a debate for a future and/or instant debate via the user interface on a mobile device.

FIG. 11 illustrates an embodiment of a layout of the web platform user interface showing future scheduled and/or featured debates viewable by users on the website.

FIG. 12 illustrates an embodiment of a layout of the mobile platform user interface showing future scheduled and/or featured debates viewable by users on a mobile device.

FIG. 13 illustrates an embodiment of how debates can be viewed by users of the present platform and the layout of debate descriptions, comments, and voting on the website.

FIG. 14 illustrates an embodiment of how debates can be viewed by users of the present platform and the layout of debate descriptions, comments, and voting on the mobile application.

FIG. 15 shows an embodiment of a publicly viewable profile of each user.

FIG. 16 illustrates an embodiment of how a user can create an instant debate to enter a community pool for debating other users who opt-in on the website.

FIG. 17 illustrates an embodiment of how a user can create an instant debate to enter a community pool for debating other users who opt-in on a mobile device.

FIG. 18 illustrates the appearance of an embodiment of instant debate notifications and participation on the website.

FIG. 19 illustrates the appearance of an embodiment of instant debate prompts on a user profile and how a user can “opt-in” to enter a pool for a debate.

FIG. 20 shows an embodiment of the user interface with notification of flagged abusive language by an AI monitoring system in real time during debates, which flagged language is to be addressed by the user and/or an online debate platform support team.

FIG. 21 illustrates an embodiment of notifications on the platform user interface on the website.

FIG. 22 illustrates an embodiment of notifications on the platform user interface on a mobile device.

FIG. 23 illustrates an embodiment of a post-debate winner indicator on a mobile device.

FIG. 24 illustrates an embodiment of an event/debate search for current and future events or debate(s) on a mobile device.

FIG. 25 illustrates an embodiment of an instant debate entry on the website user interface.

FIG. 26 illustrates an embodiment of an instant debate entry example on a mobile application user interface.

FIG. 27 illustrates an embodiment of a coin-flip selection via the mobile application on a mobile device.

FIG. 28 illustrates an embodiment of a coin-flip selection via the web user interface on the website.

FIG. 29 shows an embodiment of a user interface of the present invention on a mobile device and including live video broadcast functionality.

FIG. 30 shows further embodiments of a user interface of the present invention on a mobile device and including video commenting functionality.

FIGS. 31-32 show an embodiment of a user interface of the present online debate platform on the website via a computing device display and including video commenting functionality.

FIG. 33 shows an embodiment of a user interface of the present invention including a debate invitation prompt.

FIG. 34 shows an embodiment of a user interface of the present invention.

FIG. 35 shows an embodiment of a user interface of the present invention and live video functionality.

FIG. 36 show an embodiment of a user interface of the present invention.

FIG. 37 shows embodiments of a user interface of the present invention including user profile information and debate statistics.

FIG. 38 shows an embodiment of a user interface of the present invention and online debate platform system notification functionality.

FIG. 39 shows an embodiment of advertisement creation functionality of the present invention including a fillable online form viewable via the user interface.

FIG. 40-41 show embodiments of the user interface including advertisement preview functionality.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In an exemplary embodiment of the present invention, an online debate platform deploys unique artificial intelligence (“AI”) applications, including but not limited to effectively monitoring obscene lingual and abusive words used by people who are debating on the platform. In an exemplary embodiment of the present invention, the present online debate platform allows users to debate other users via split screen video.

In an exemplary embodiment, while debating in real time video, two opponents are monitored by an AI system of the present platform in real time or near real time to check for abusive or inappropriate language. In an exemplary embodiment, the AI system integrated into the online debate platform is configured to monitor language during the debate without first requiring a user to flag abusive or inappropriate language. Rather, in an exemplary embodiment, the AI system is configured to learn and adapt to what is acceptable language in live debates and what is non-permissible, abusive language. Once flagged by the AI system, users are notified with warnings, and depending on the severity of the offense, such users can be banned or suspended from the online debate platform after an internal review.

In an exemplary embodiment, the online debate platform system of the present invention includes a system server computing device including a processor connected to remote user computing devices over a communications network. In embodiments, the user computing devices are smartphones, tablets, laptop computers, desktop computers, and/or any other type of computer device having a display and configured to connect to a communications network. In an exemplary embodiment, the online debate platform system allows users to utilize a microphone and/or camera connected to or integrated within user computing devices. In an exemplary embodiment, the communications network comprises the internet, an intranet, or any other type of wireless or wired communications network. In an exemplary embodiment, the online debate platform includes iOS mobile application, Android mobile application, and web-based versions of a user interface.

In an exemplary embodiment, the system further comprises a database having storage media and configured for storing system information. In an exemplary embodiment of the present invention, the system processor is programmed with an AI model which includes speech to text transcription functionality. In an exemplary embodiment, the AI model is trained with a list of obscene or inappropriate words and phrases not allowed on the platform as a dataset. In an embodiment, the AI model is further trained with scenarios including verbal use of obscene or inappropriate language such that the AI system is configured to identify and flag such obscene or inappropriate language in real or near real time as a user is speaking during a debate. In an embodiment, the AI monitoring system is further configured to detect negative sentiment and tone of a user's comments. In an exemplary embodiment, if obscene or inappropriate language is detected, such language is added to the dataset and saved to the system database.

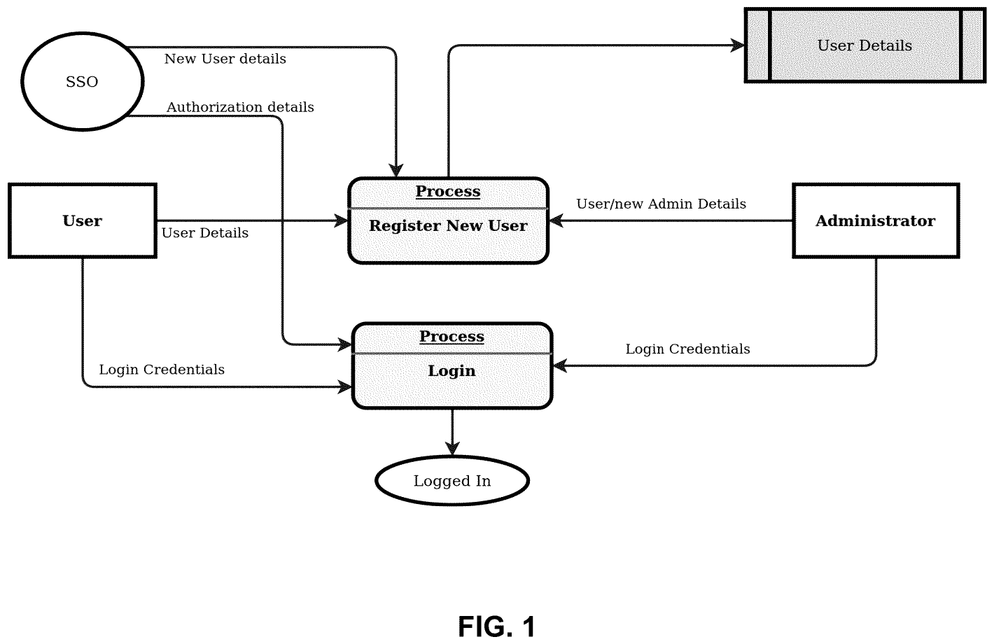

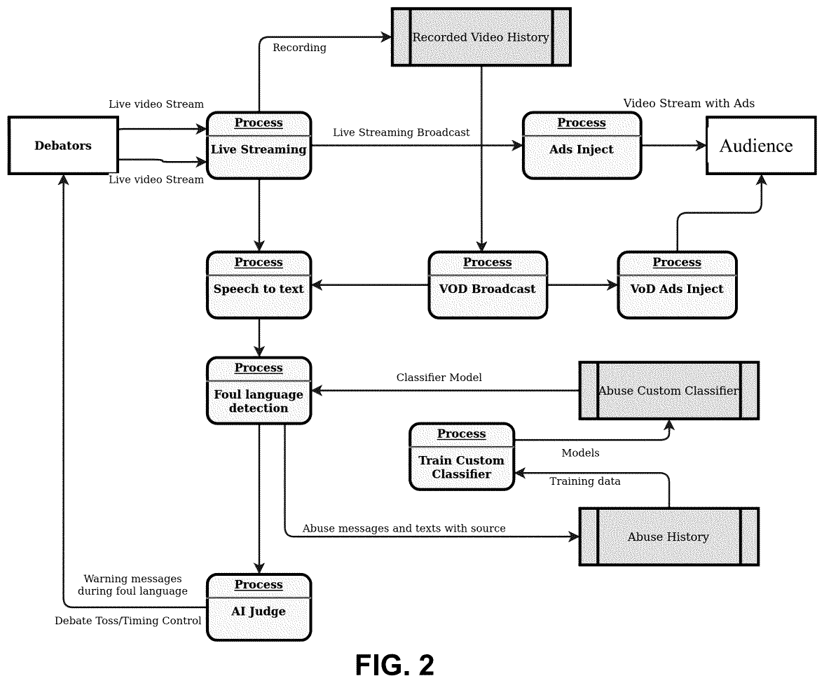

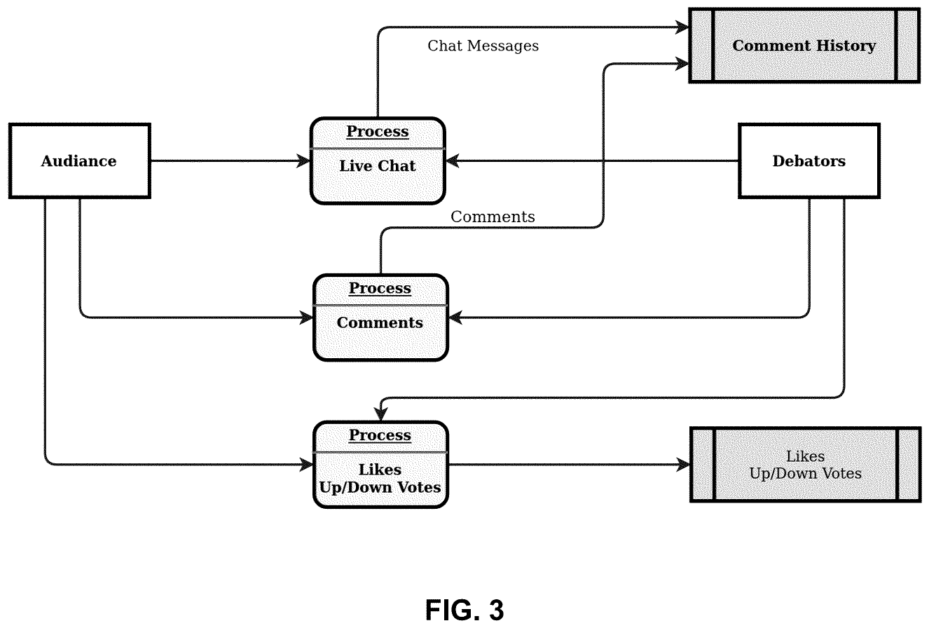

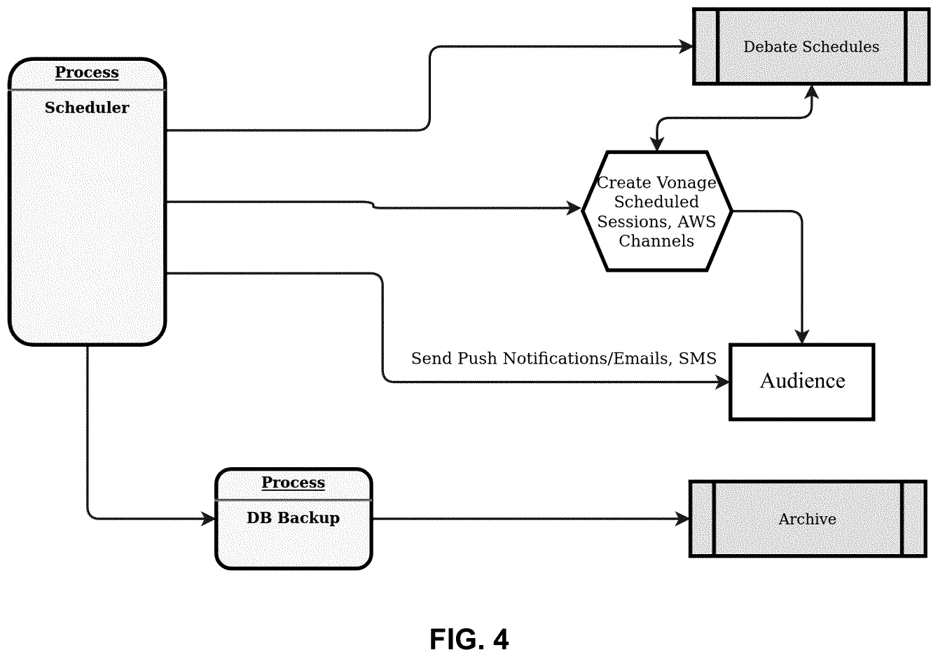

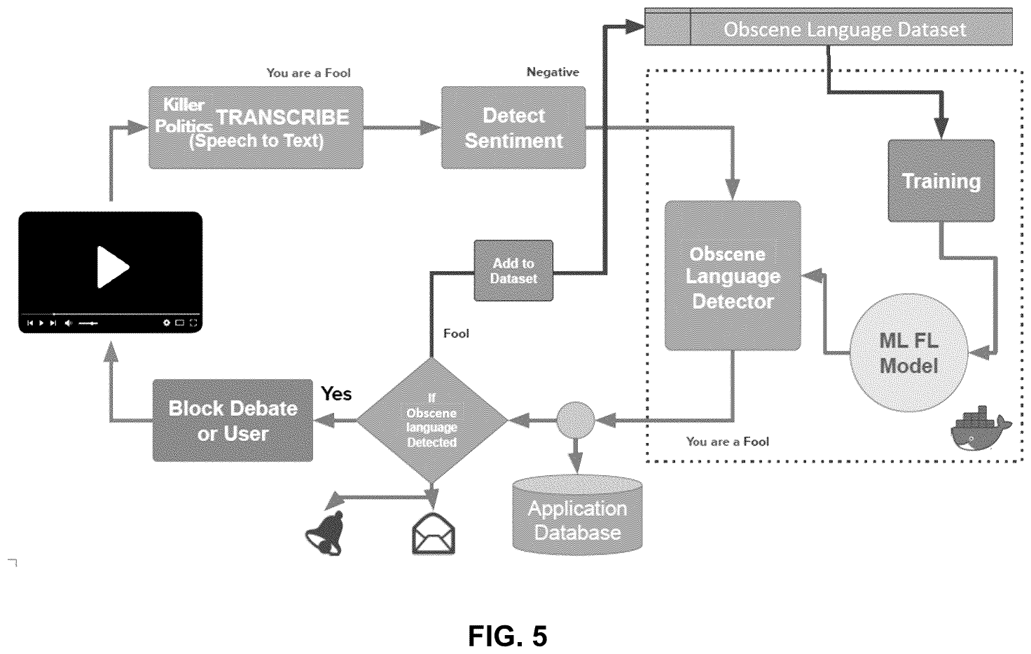

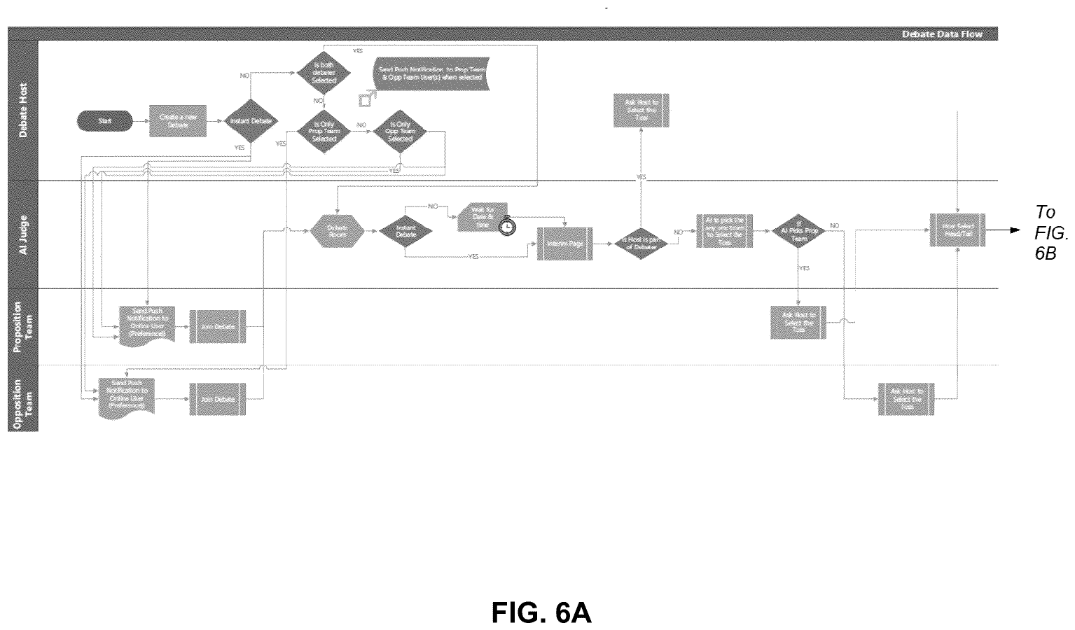

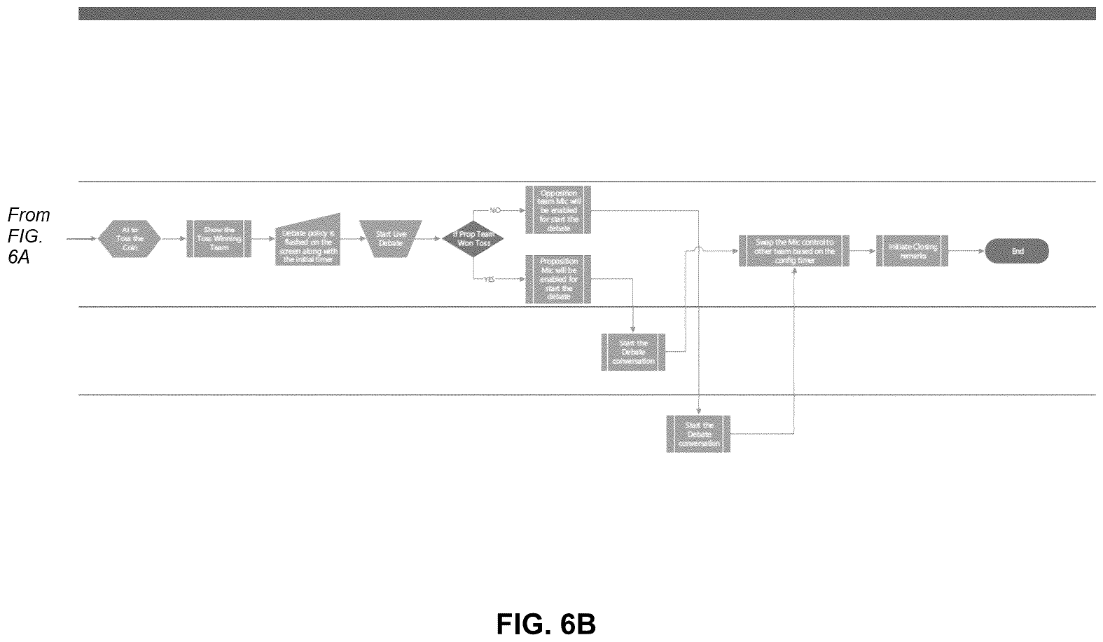

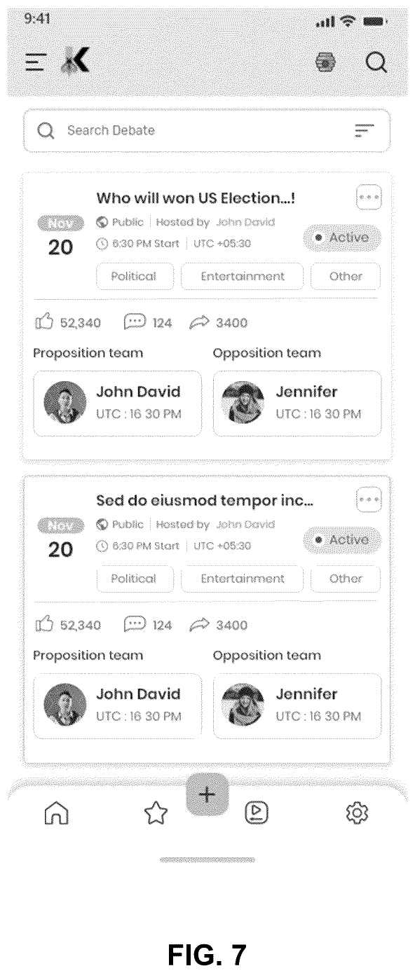

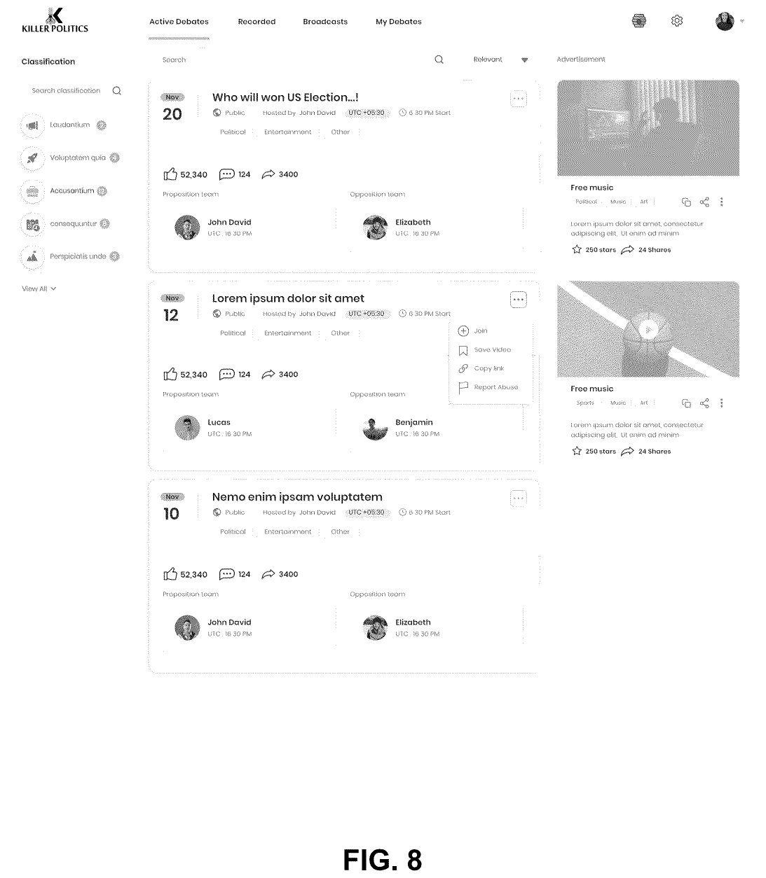

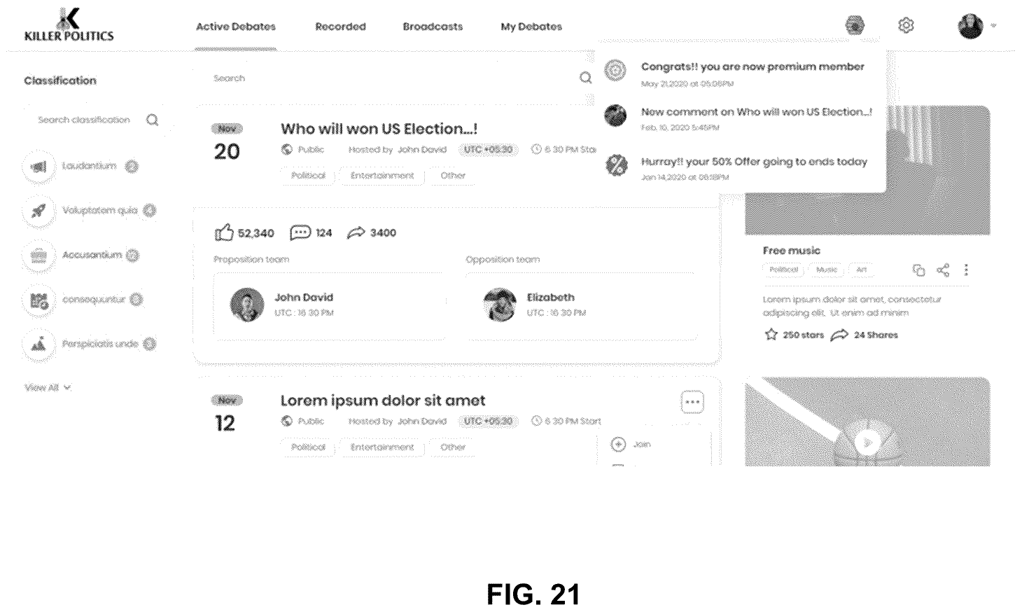

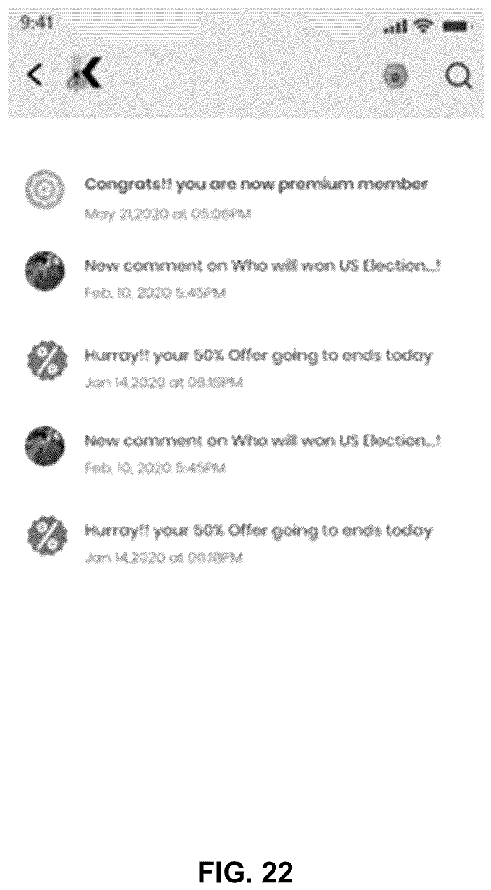

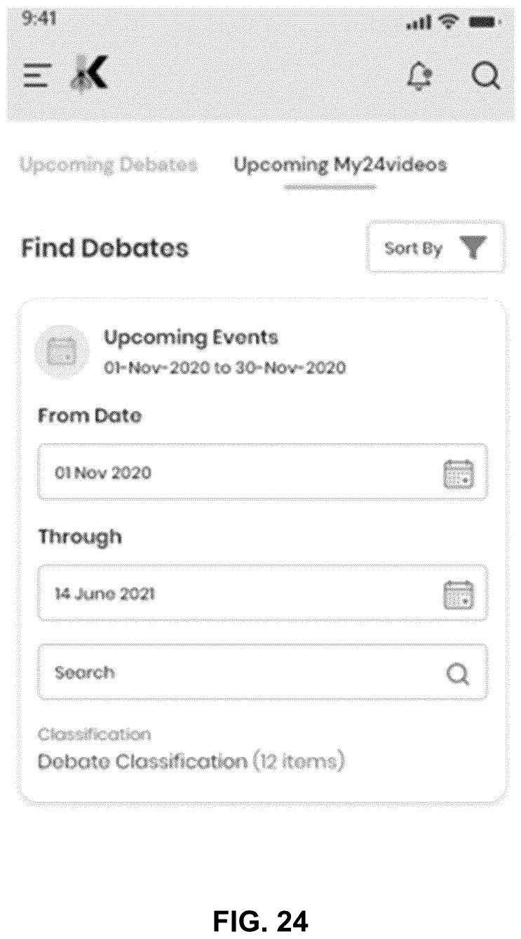

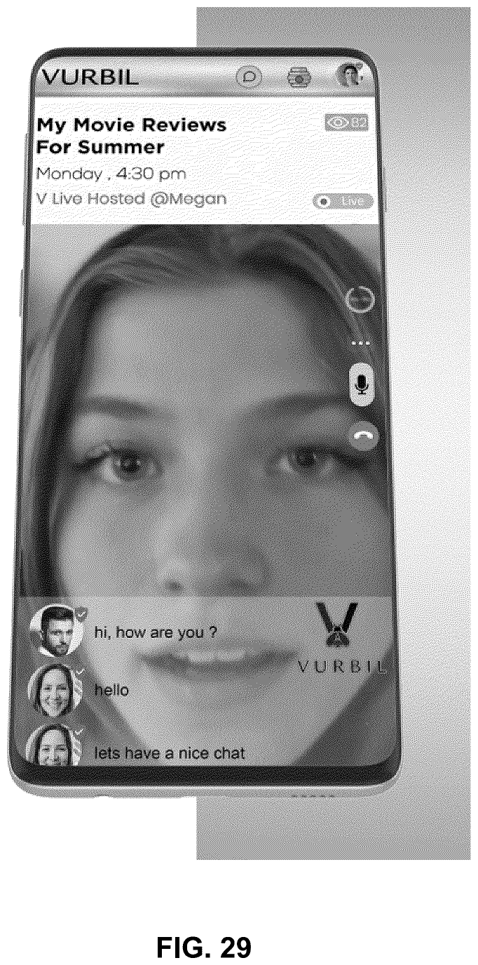

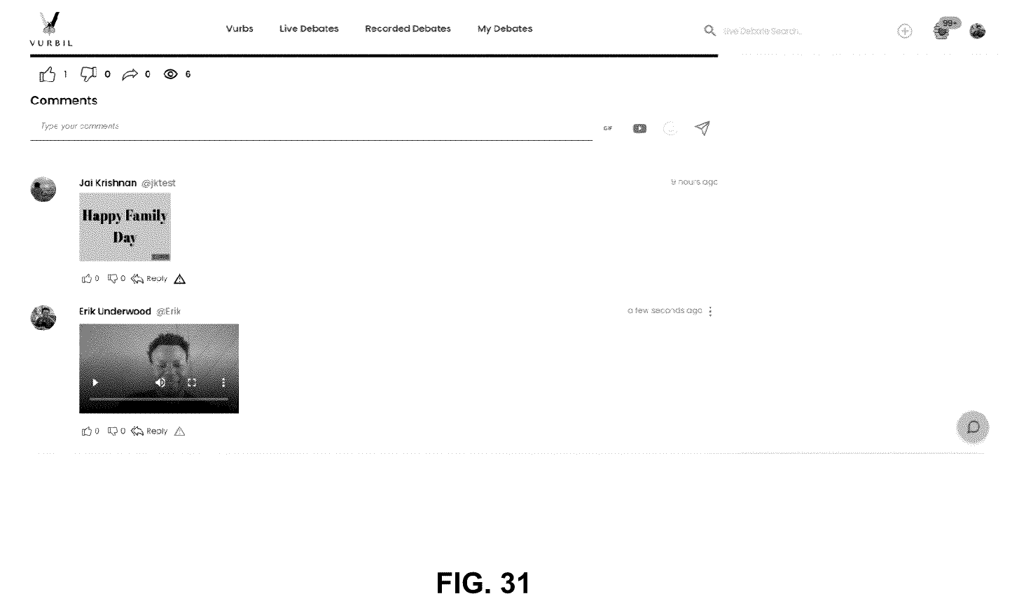

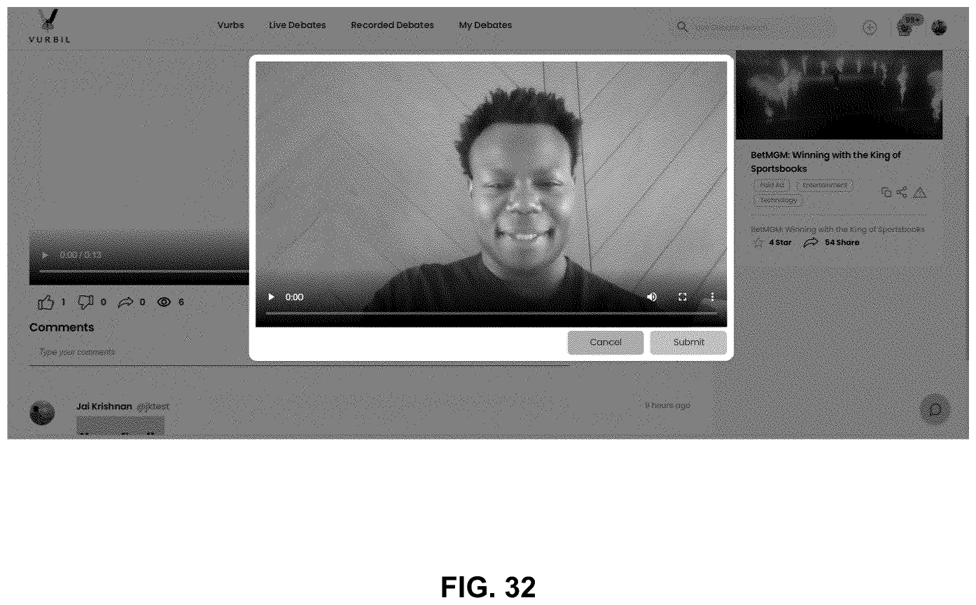

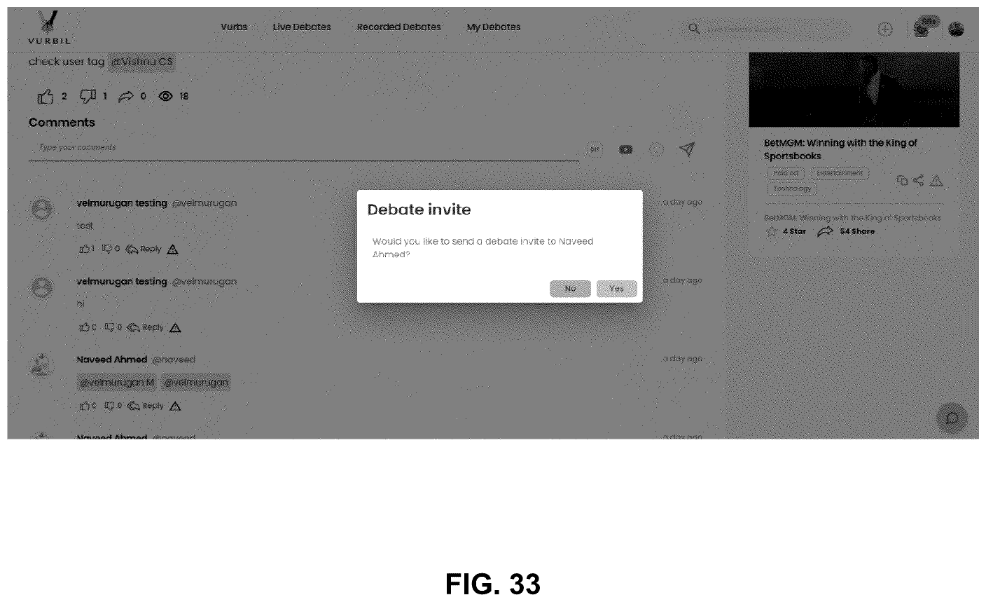

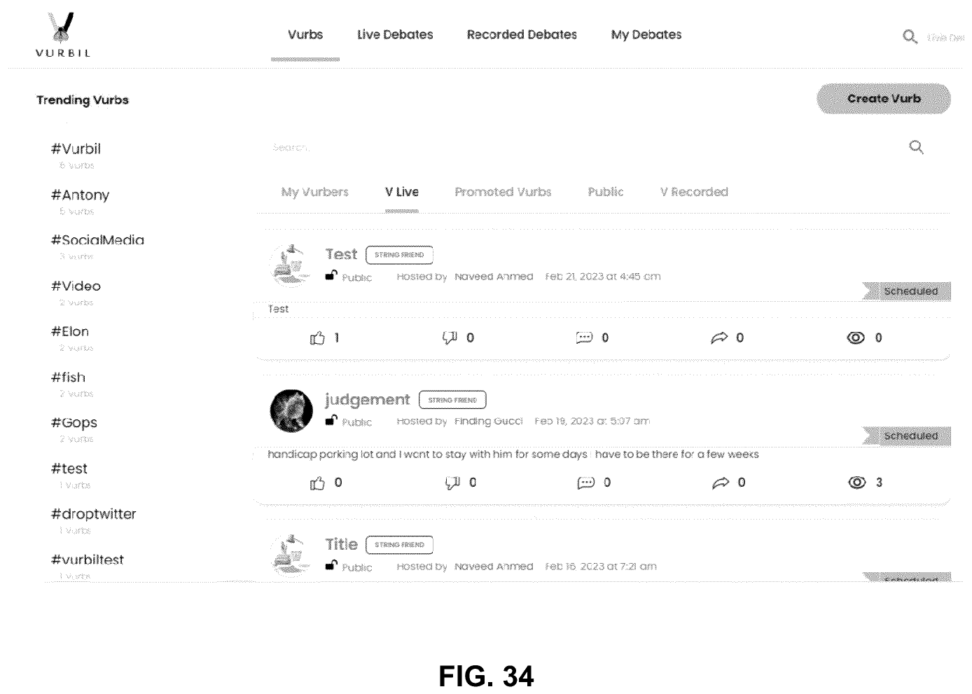

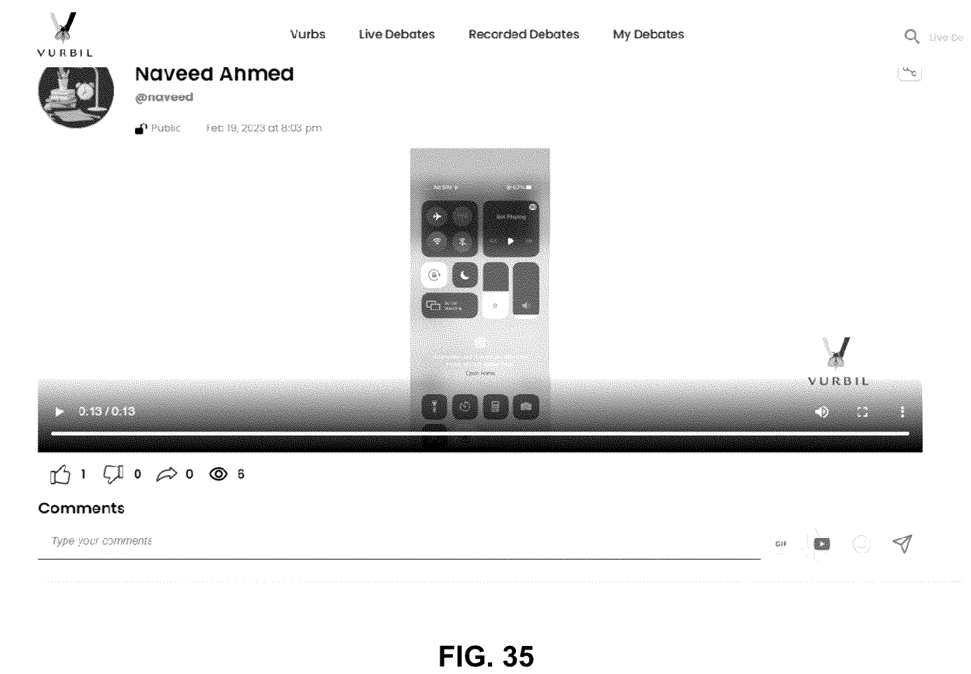

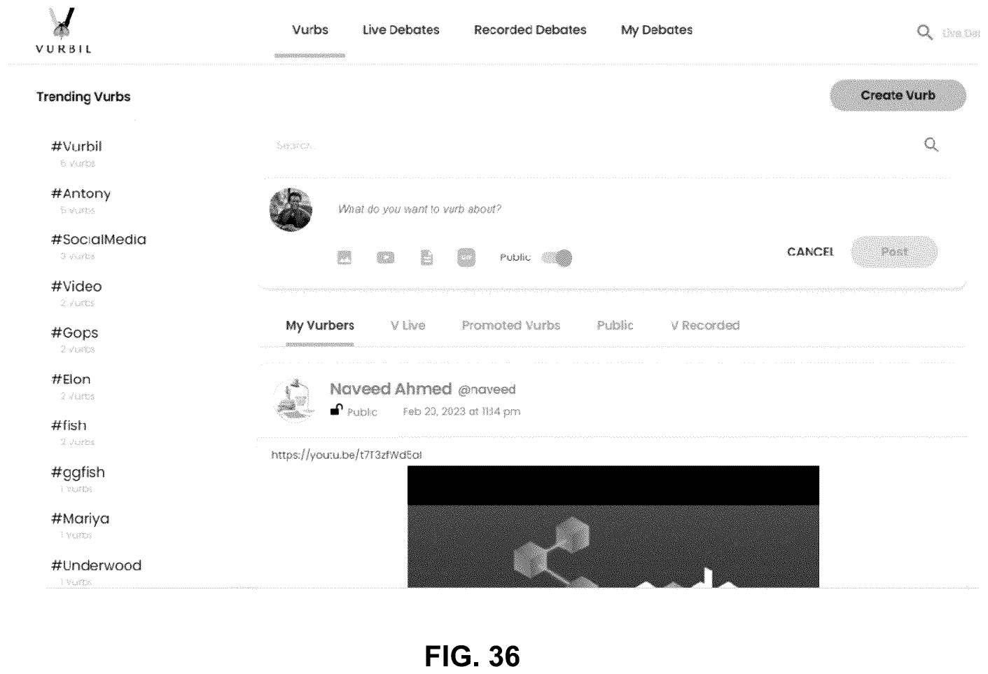

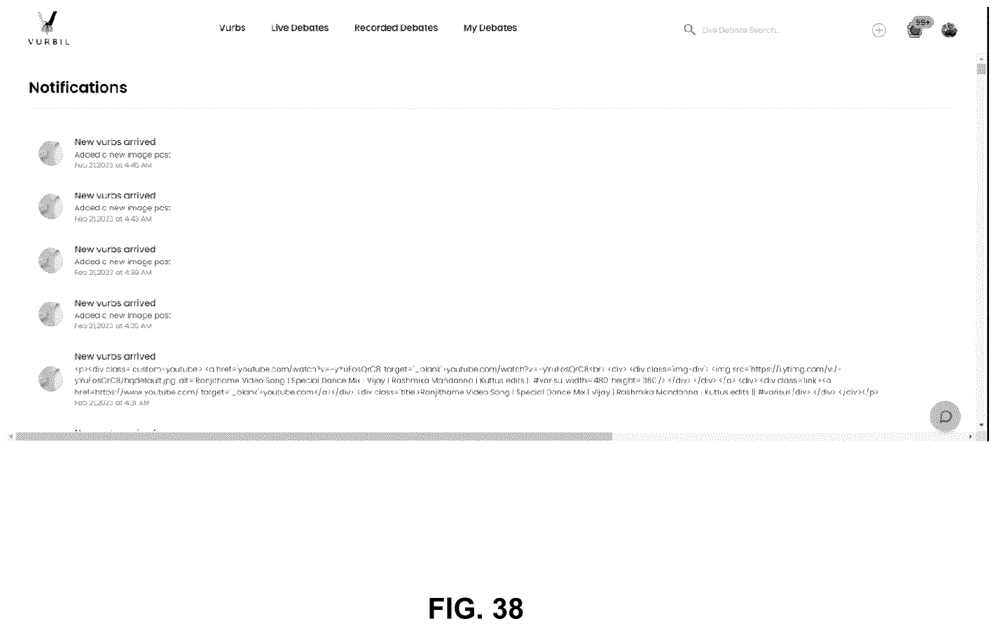

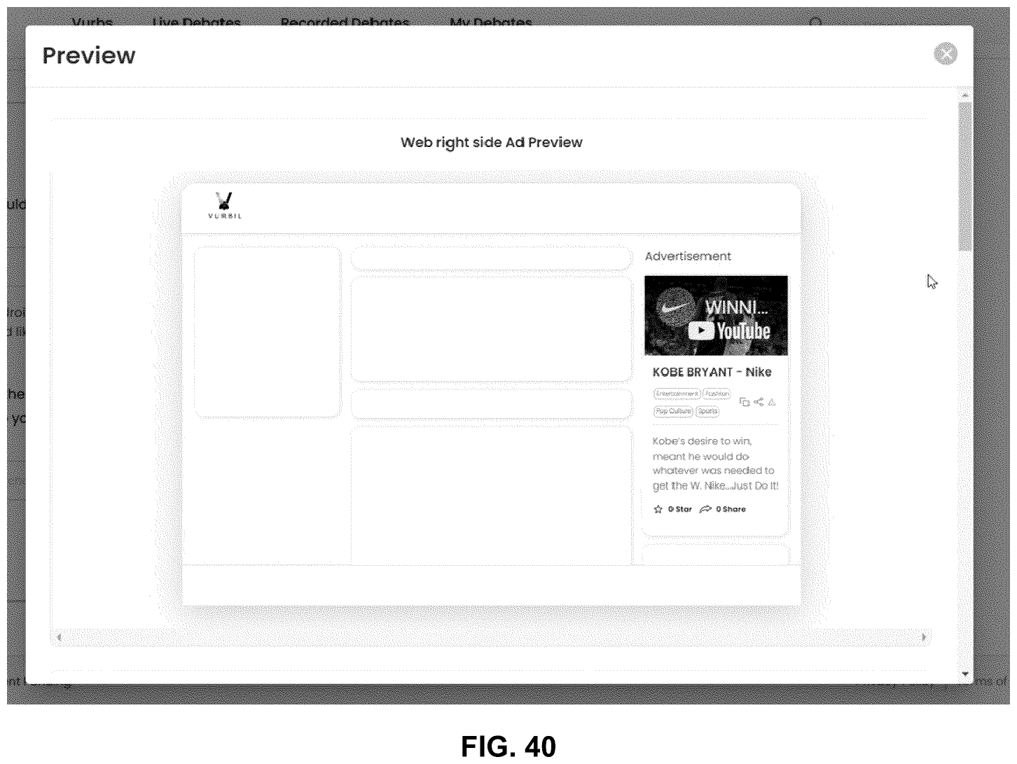

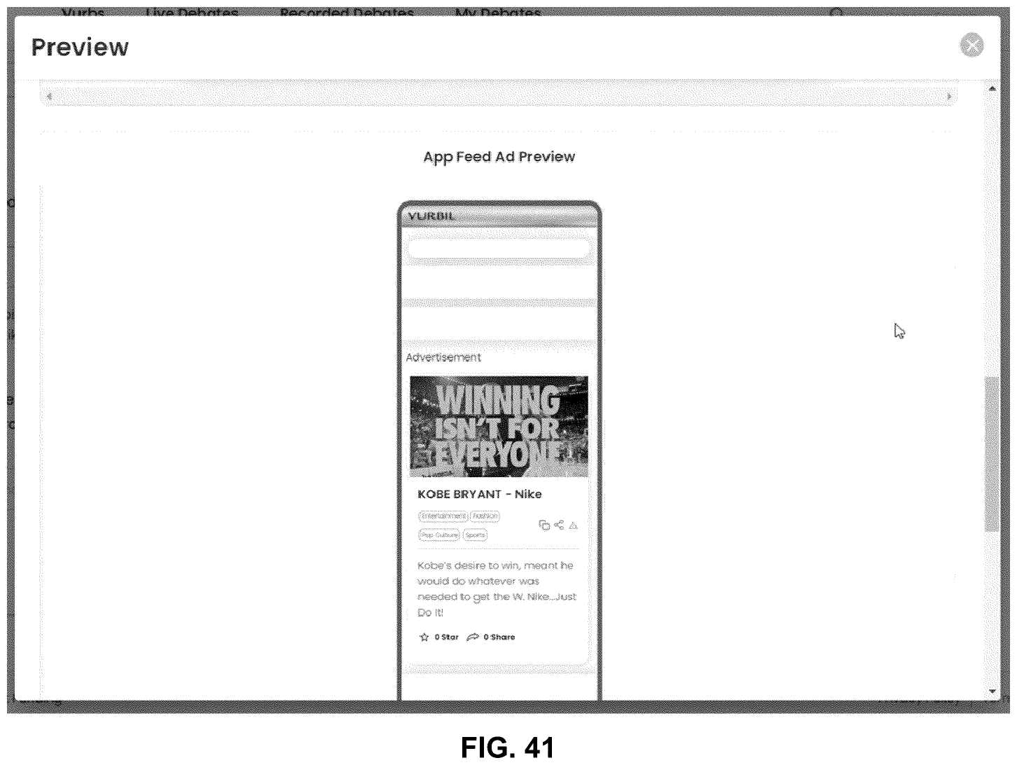

Referring to the drawings in more detail, FIG. 1 is a schematic diagram of a user dashboard and profile setup and login system. FIG. 2 shows a schematic diagram of live streaming and video on demand (VOD) broadcasts on the present online debate platform. FIG. 3 is a schematic drawing of comment section functionality of the online debate platform, including comments, likes, and votes. FIG. 4 is a schematic drawing showing a system for scheduling debates and notifying users via the present online debate platform. FIG. 5 is a schematic drawing illustrating the AI language monitoring system of the present platform. FIGS. 6A and 6B show a flow chart displaying data flow during a debate between users on the present online debate platform. The flow chart further shows digital coin flip functionality of the present invention. FIGS. 7-41 show various embodiments of an online debate platform user interface of the present invention, including web browser and mobile application embodiments of the user interface.

One of the many features available to the users of the present online debate platform includes an option to instantly debate active users on the platform. As such, if a user wants to debate another user in real time, that user can either join or create an instant debate topic and open it up for registration by another active user who is of the opposite stance (proposition vs. opposition). In an exemplary embodiment, the AI system is equipped to instantly match a user with another active user if such user “opts-in” to join a current instant debate available.

Prior art social media platforms let many toxic and abusive comments be posted without recourse. Such comments are not conducive to a civil debate, and the public at large has no way of declaring a winner in conjunction with tabulated votes. There is no clear flow of debate, and users on currently popular social media platforms often find themselves inundated with comments and arguments from all sides without the opportunity to productively continue the dialogue before it gets out of hand.

In an exemplary embodiment, the online debate platform incorporates an AI system that controls active debate user participation by providing a digital coin-flip to see who goes first in a debate. In embodiments, the AI system also monitors the time slot of who is speaking and mutes the microphone of the user who is waiting in turn, so every voice is heard in the debate. In embodiments, each user is also alerted when such user's allotted time is almost up or about to start.

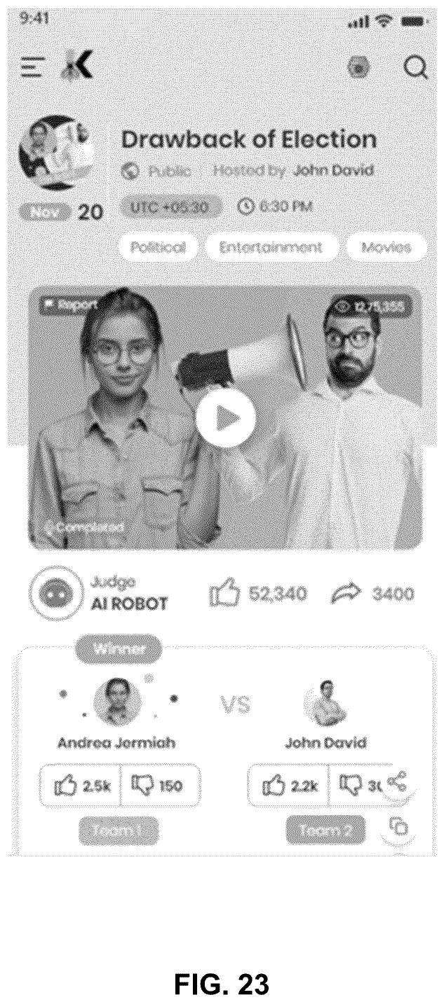

In an exemplary embodiment, following or during a debate, other users publicly vote on a “winner,” and the winner is displayed instantly. Allowing the participants and audience to see the winner instantaneously, as shown in FIG. 23, promotes and encourages concise and well thought out arguments by each participant to attempt to achieve a sense of “instant” gratification. Encouragement of well-articulated arguments within the time limit set by the platform promotes the potential for maintaining the “win” as viewer traffic increases for publicly viewable debates and as users debate more frequently.

In an exemplary embodiment of the present invention, prior to the start of each debate, the system is configured to launch a pre-roll video introduction of the debaters and the debate topic. In embodiments, a user can customize information provided in such video introduction. In embodiments, the video introduction provides statistics about each debater and/or the debate topic itself (e.g., how many times it had been debated on the platform, links to related debates).

By regulating the time allotments for each debate and actively monitoring the platform for abusive or inappropriate content, the present online debate platform accommodates a social media experience for individuals who want to express their viewpoints and be heard without interruption.

### Registration and Initial Participation

In an embodiment of the present invention, when a user registers with the platform, such user is able to fill out a profile with information which is checked for legitimacy through the online debate platform. As a built-in check for legitimacy, the information provided by each user is required to be established and accurate as described in more detail below. The present online debate platform, with the assistance of functioning AI capability, along with an online debate platform support team, regularly monitors and checks each user profile after initial registration. In an embodiment, the users of the platform, upon initial registration, have an option to sync or upload their information via other social media platforms, such as but not limited to Facebook, LinkedIn, and Google. In embodiments, potential users are notified via email if their initial registration does not pass the user guidelines, as set by the online debate platform, before they have access to the full platform. In embodiments, usernames on the online debate platform are required to be close to the user's real name. For example, acceptable variations of a username for a user named “John Smith” could be as follows: J. Smith, John.S, John.Smith, John Smith, J.Smith90, etc. In embodiments, the profile pictures uploaded are to be of the user only to maintain user authenticity. In such embodiments, no filters, group pictures, or cartoon “filler” will be permitted as a profile picture for each user. If the user does not have an acceptable profile picture readily available, they will have the opportunity to register natively on the online debate platform and take a profile picture via the profile picture upload image function on the platform.

The authentication process is nearly instantaneous assuming the initial guidelines are met (i.e., a real photo, name, and confirmed email). In an embodiment, upon such authentication, the end user receives a notification that the user's profile is now “live” on the online debate platform. If, upon registration and possible later review by the platform support team, a violation is found, the user will have a temporary suspension on the user's profile until such violation is corrected and approved by the platform support team. If future violations are found by the platform support team, the user will be immediately notified. The user profile will remain suspended from the online debate platform until the violation is corrected and approved. This establishes a precedent of accountability for each user. In an exemplary embodiment, after approval, users are able to (i) participate in debates, watch debates, comment on debates, and share debates; (ii) watch online debate platform video news blasts, comment on the online debate platform video news blasts, and share the online debate platform video news blasts; and (iii) watch an online show, comment on the online show, and share the online show.

### Profiles/Instant Messaging/Friend Requests

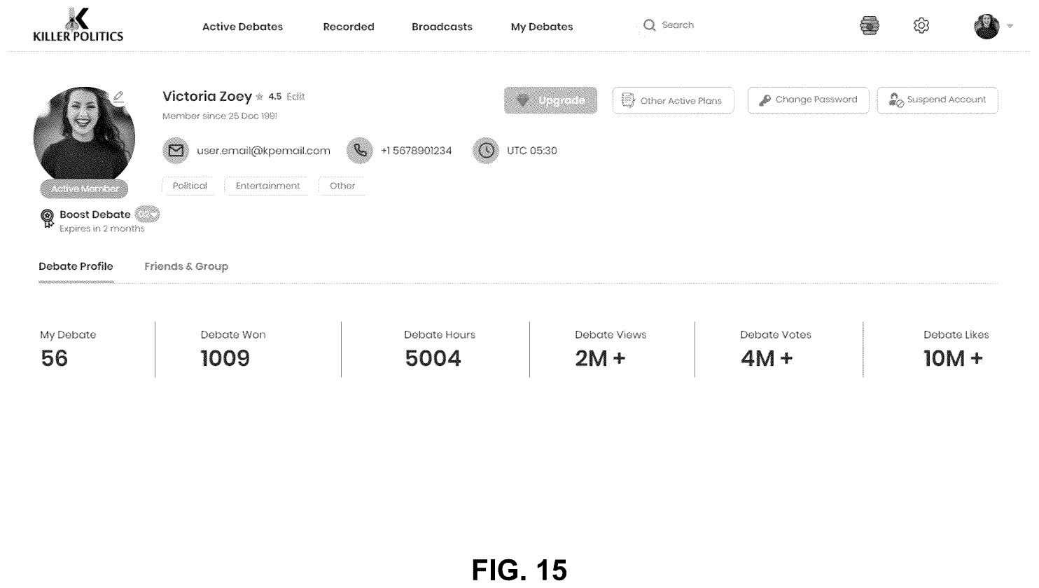

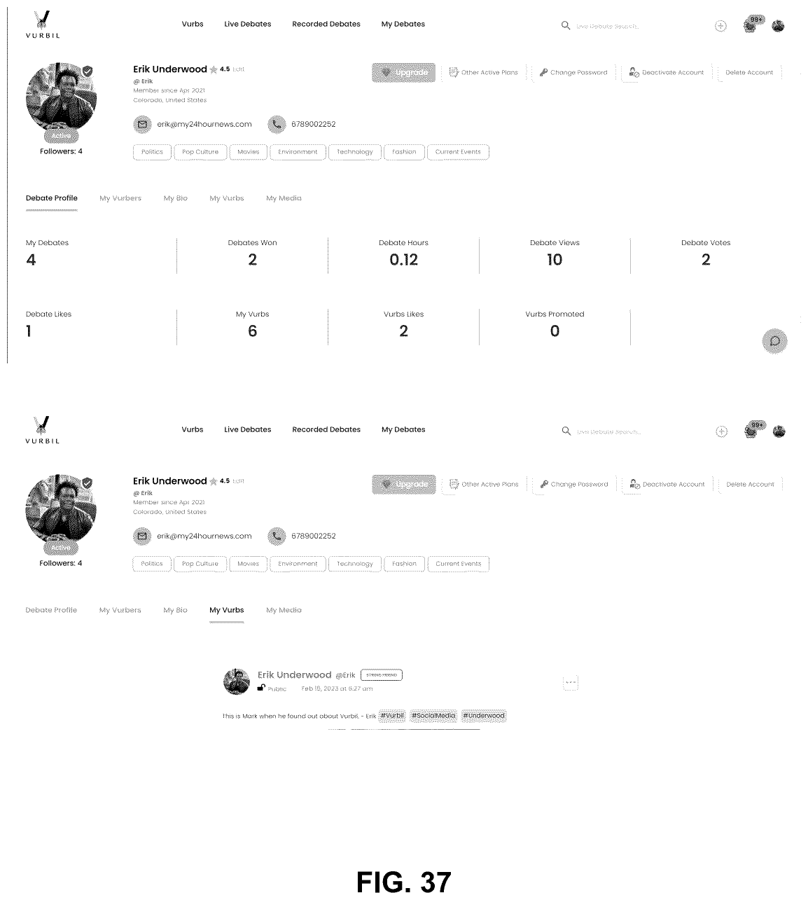

In an exemplary embodiment, once a user profile has been created and approved, such profile becomes public, and the user gains full access to the online debate platform. A platform user will have the option to publicly display their email address and phone number, as well as a selection of debate metrics. In an exemplary embodiment, the following metrics are always viewable to the public: My Debates, Debates Won, Debate Hours (broken into increments), Debate Views, Debate Votes, and Debate Likes. In embodiments, private profiles are not permitted on the online debate platform, and only certain metrics and information can be optionally hidden from public viewing. FIGS. 15 and 37 show embodiments of a public profile of the online debate platform.

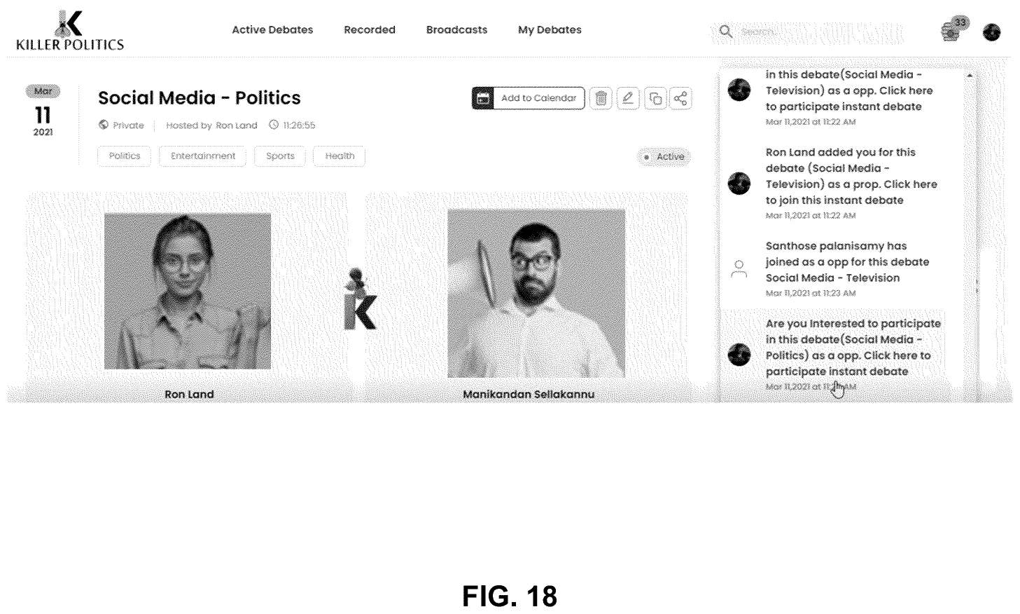

In an exemplary embodiment, users can also customize their profiles for specific topics, video news blasts, notifications, and like content. FIGS. 18, 21, 22, 34, and 36 show embodiments of customizable online debate platform profiles.

In an exemplary embodiment, on the platform, users will also have the option of instant messaging other users to continue discussions, establish new networking opportunities, and potentially establish debate partner(s) for future topics.

In an embodiment, users of the online debate platform can befriend other members on the platform by “stinging” them. The “stung” user will have the option to accept the friend request or to reject the friend request at the user's discretion. If a platform user opts to unfriend another user on the platform, they can locate the user(s) on their friends list and “unsting” them to remove them from their friends list.

In an exemplary embodiment, users can opt-in to view debate topics of choice, creating a more personalized platform experience. In an exemplary embodiment, users can discover relevant debate content tailored to their interests, provided by a user-selected algorithm derived from the user's predetermined interests (e.g., sports, politics, pop culture, etc.).

In embodiments, users drive accountability by rating fellow users with a community-based rating system. Such rating system includes a “user star rating” which is affected by user ratings and total engagement on the platform via debates, voting, ratings, etc.

In embodiments of the present invention, users can comment on another user's post on the platform, and such users are prompted to debate each other based on the topic or content of the post. Such prompt is configured to launch a new debate between the users.

### Video Debates: Scheduled, Instant, or Curated

### Option 1: Scheduled Debate

In an exemplary embodiment of the online debate platform of the present invention, a user has the option to schedule a future debate on a predetermined topic with another user for public, private, or limited viewership, as diagrammed in FIG. 4. In an exemplary embodiment, when a debate is scheduled, a debate web channel is created, notifications are sent to potential audience users, and the scheduled debate is backed up on the system database and archived. Users also have the option to register to participate in curated debate(s). In embodiments, the platform user has the option to invite specific other platform users to participate or to be notified when a curated debate topic goes “live” for participation. Once a user is notified of a “live” curated debate, such user can also schedule a debate with another user at this time.

In an exemplary embodiment, a platform user can schedule a debate with another user as desired by creating a new debate topic if one does not exist according to their preferences.

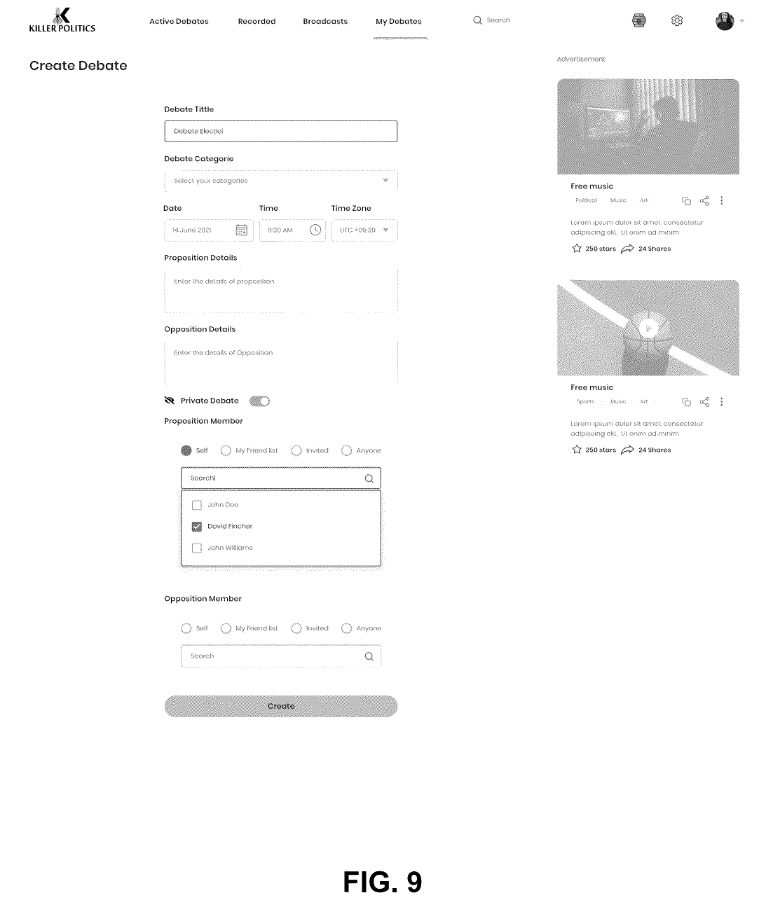

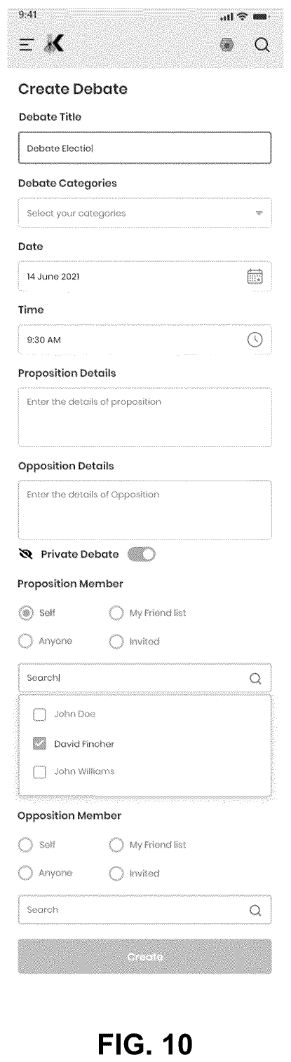

If a user opts to create a debate, the user will be directed to the debate creation page to fill out the various metrics and their opted position of proposition/opposition. FIGS. 9 and 10 illustrate how a user can fill out debate information, select a position, and either invite a specific user or place it in the pool for any user to opt in on or before the preselected date in embodiments of a user interface on the system website and via a mobile application, respectively.

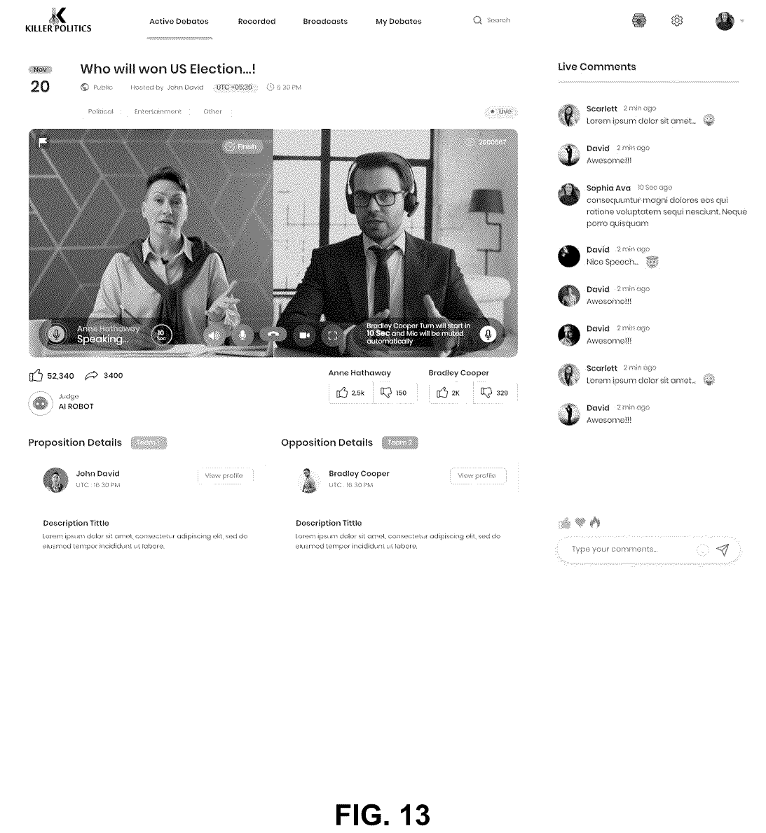

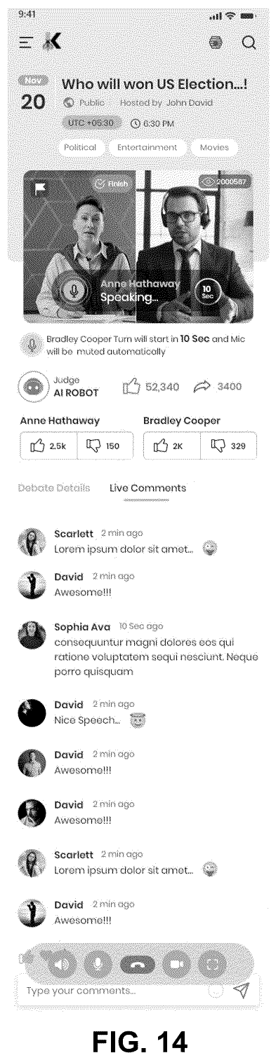

If a user of the online debate platform does not want to actively participate in the debate, such user can watch, comment, and/or vote on live debates taking place on their newsfeed or can view previously recorded debates in various categories of the user's choosing to watch, comment, and/or vote. In further embodiments, a user can host a debate between other users rather than participate on either side of the debate. FIGS. 13 and 14 show embodiments of a web user interface and a mobile device user interface, respectively, for watching, commenting, and/or voting on debates.

### Option 2: Instant Debate

In an exemplary embodiment, similar to the debate creation page shown in FIGS. 9 and 10, a user can create a debate to be “instantly generated” and available to active users.

Once the instant debate topic is live, users can select their position on the debate topic and enter the “pool” of debaters to be randomly paired with a user of the opposing viewpoint as generated by the online debate platform AI system. Although generally the “pool” is the collection of debaters that are currently live on the online debate platform, when referenced specifically within an instant debate, the “pool” is the term for the users who have selected the same position for the instant debate who will then be paired with a user from the opposing point of view “pool.” This guarantees the user will not be unintentionally paired with a user of the same viewpoint.

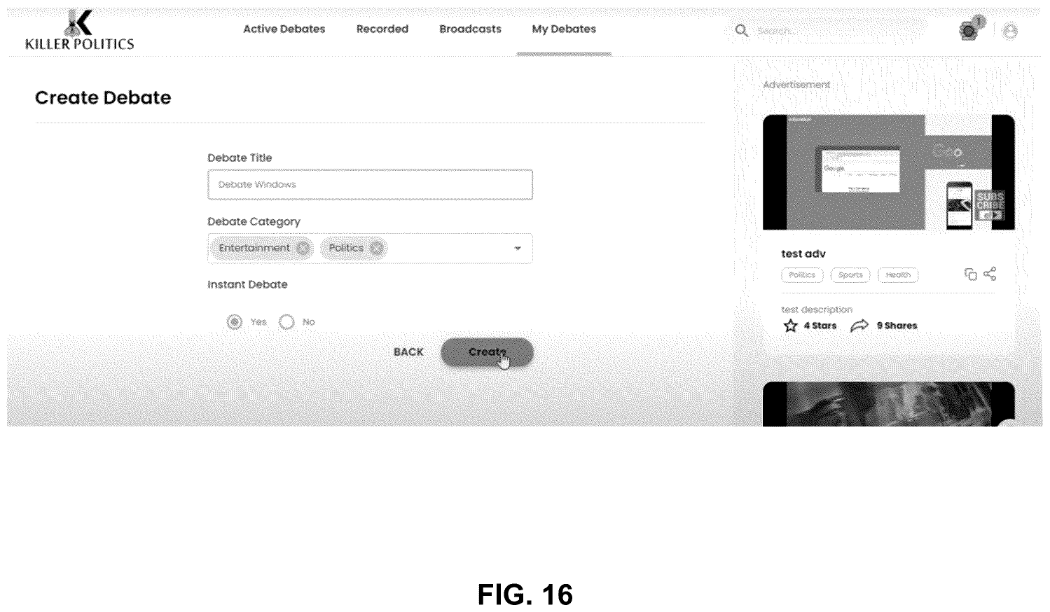

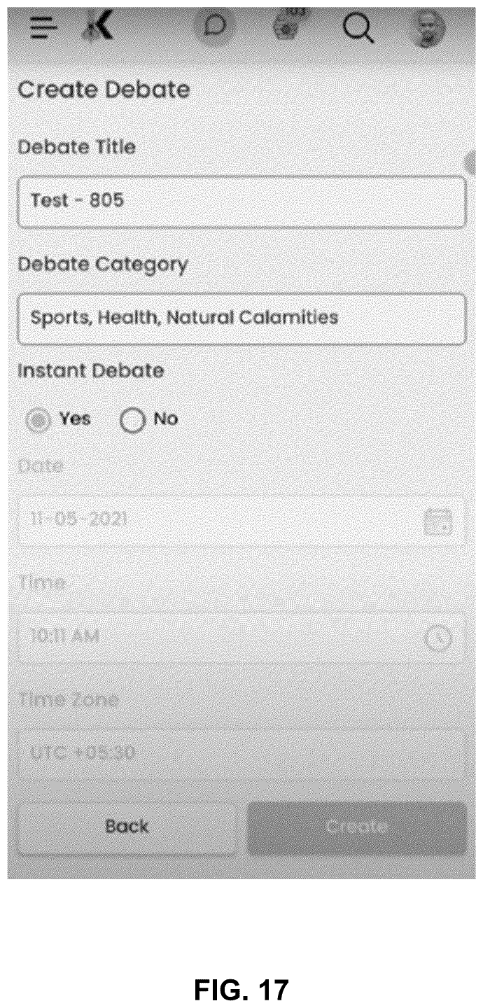

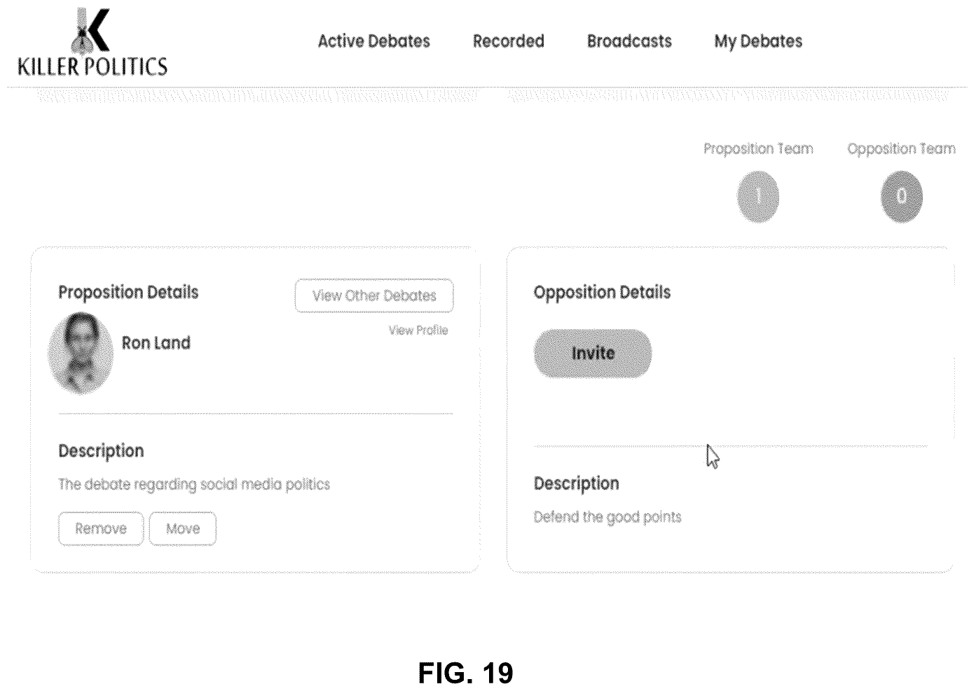

New instant debates provide users with a notification similar to news blasts, the online show, online debate platform curated debates, and other promotional notifications. FIG. 18 shows an embodiment of an instant debate notification of the online debate platform. To participate in an instant debate, a user has multiple courses of action available. The user can click on a push-notification alert or email, select to join in either the proposition or opposition section on a trending instant debate on their news feed as shown in FIG. 19, or search via the instant debate section under an Active Debate tab. If an instant debate is not already created for debaters to enter either the proposition or opposition debate pool for random pairing, the user can create an instant debate to be live for the platform users to participate, as shown in FIGS. 16 and 17.

In an embodiment, there is another instant debate option that is available to platform users via the online debate platform curated debate. Once a curated debate is “live” on the platform, a user can either invite another user to participate (if a debate was not scheduled in advance) or register in the debate for a specific stance much like an instant debate to be randomly paired with an online user in the opposing point-of-view.

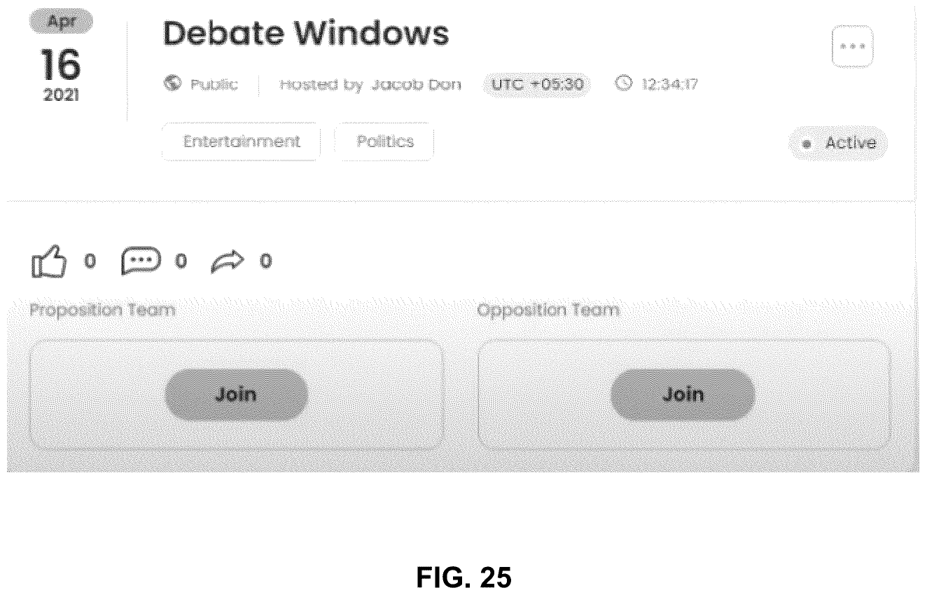

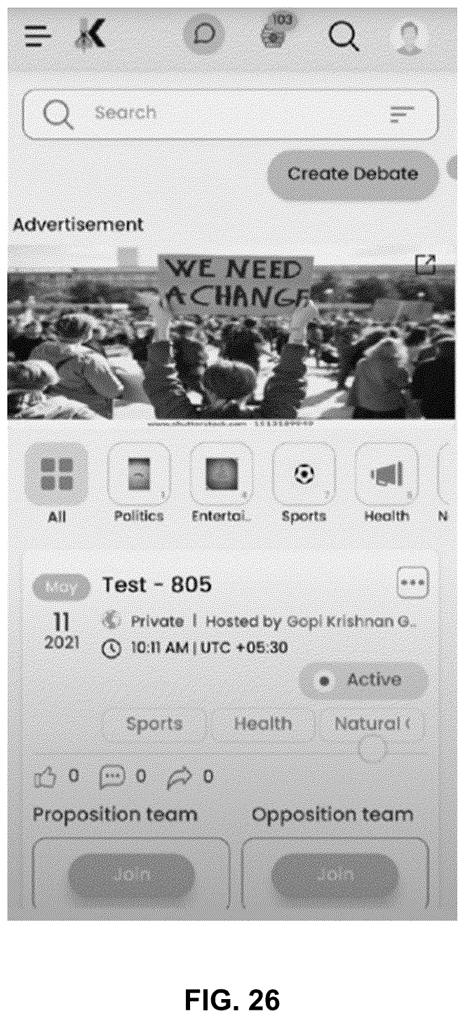

In an embodiment, random pairing of an opposing point of view for a curated debate is only generated once the platform user selects “join” for the debate, as shown in FIGS. 25 and 26. If a user has not already selected a stance, in which their information would be automatically generated, such will have the option to do so much like in an instant debate as illustrated above.

If a user of the online debate platform does not want to actively participate in the debate, a user can either watch, comment, and/or vote on live debates taking place on their newsfeed or such user can view previously recorded debates in the various categories of their choosing to watch, comment, and/or vote. FIGS. 13 and 14 show exemplary embodiments of comment sections of the present platform on the website and on a mobile device, respectively.

### Option 3: Curated Debate

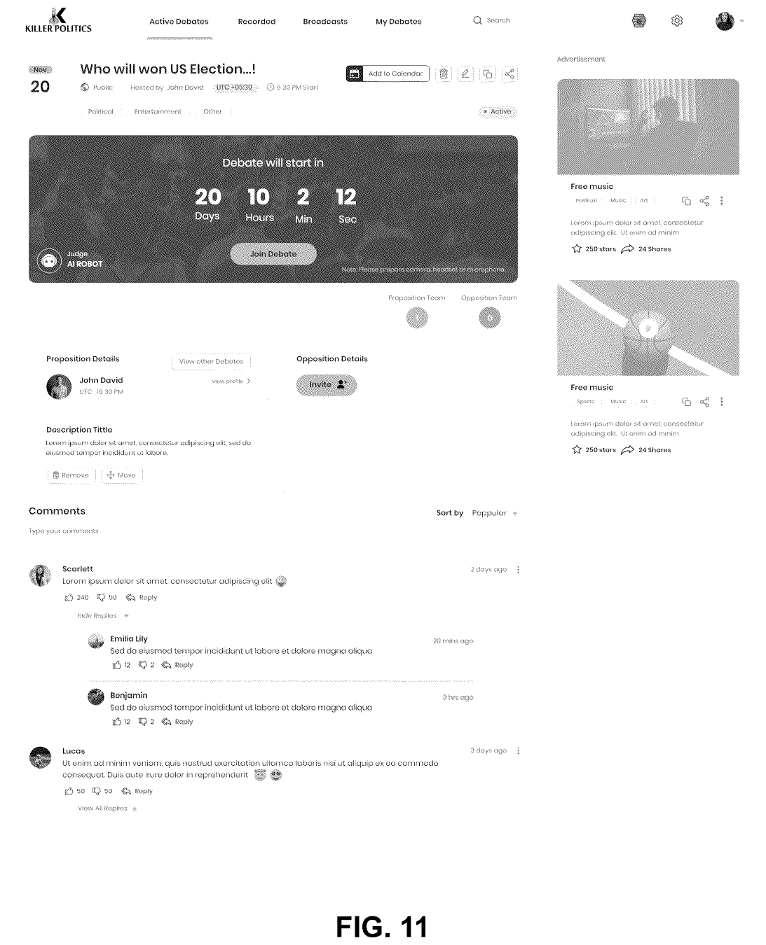

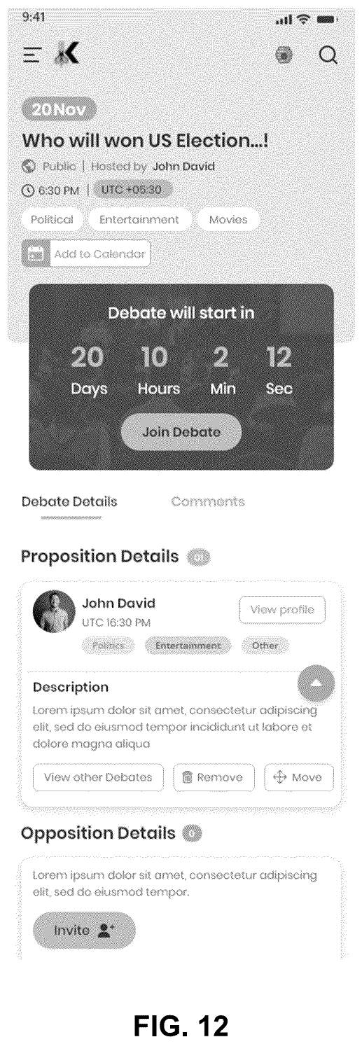

In an exemplary embodiment, the online debate platform team curates topics for debate based on trending subjects, for example, celebrity breakups, sports figures, entertainment award nominations, political nominations, etc. Curated debates differ from instant and scheduled debates in the sense that these debates are hot-topic issues that are known to take place well into the future. For example, political elections, upcoming award shows, etc. FIGS. 11 and 12 show embodiments of a user interface of the present online debate platform with curated debates.

In embodiments, platform users also have the option to register to participate in curated debate(s). The platform user will have the option to invite specific users to participate or to be notified when the debate topic goes “live” for participation. Once the curated debate is “live” on the platform, a user can either invite another user to participate (if a debate was not scheduled in advance) or register in the debate for a specific stance much like an instant debate to be randomly paired with an online user in the opposing point-of-view.

If a user of the online debate platform does not want to actively participate in the debate, a user can watch, comment, and/or vote on curated debates taking place on their news feed or view previously recorded debates in the various categories of their choosing to watch, comment, and/or vote.

### Coin Flip Functionality

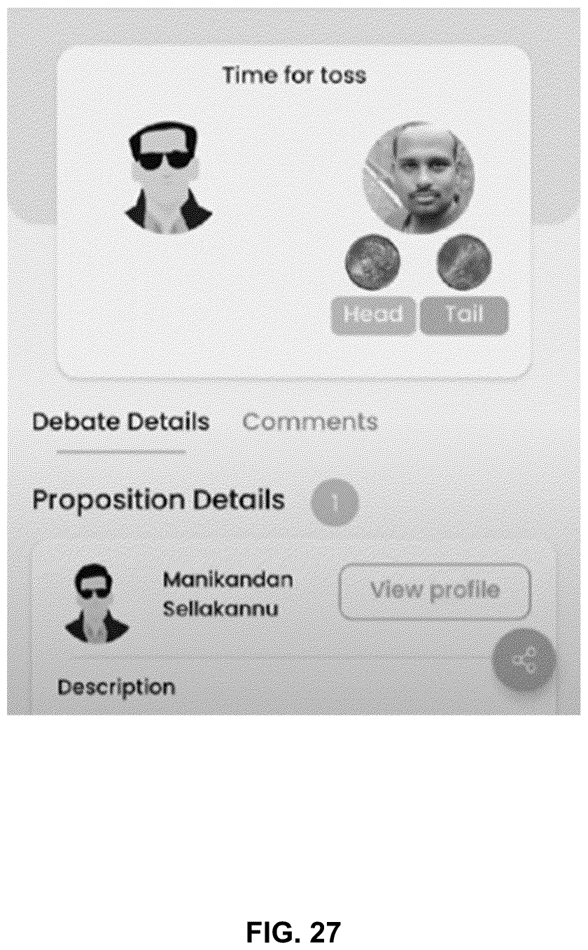

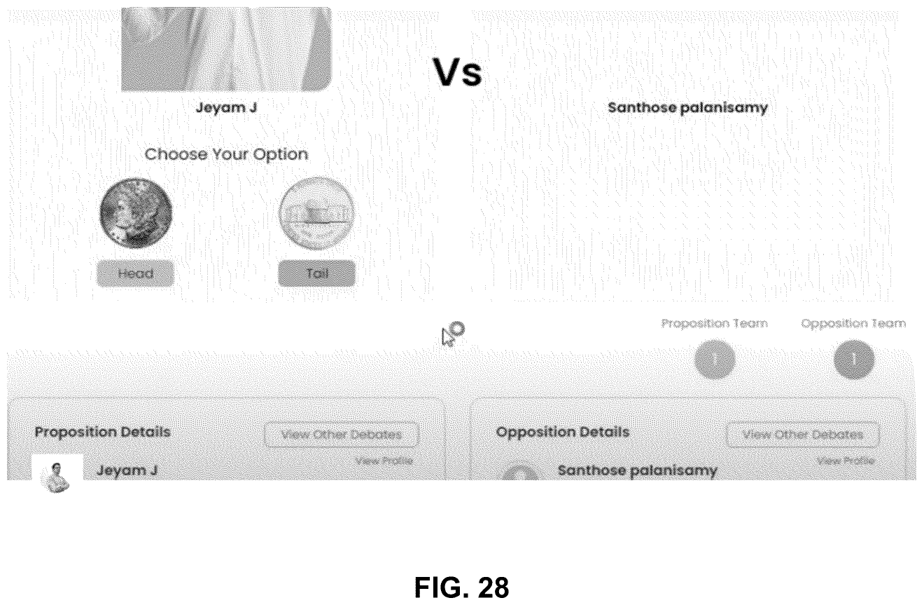

In an exemplary embodiment, the online debate platform AI system allows for each debate participant to see who goes first through a virtual coin-flip. This mechanism provides for a fair and clear, random determination of which platform active debater will start the debate and which platform active debater will close the debate. FIGS. 6A and 6B show a flow diagram of the virtual coin-flip and debate flow moderated by the AI system. FIGS. 27 and 28 show embodiments of a user interface including a virtual coin-flip. In an exemplary embodiment, the AI monitoring system is configured to further control timed debate segments and to control muting and unmuting of microphones of debate participants.

### Online Show and News Blasts

In an exemplary embodiment, the online debate platform uniquely also provides a weekly synopsis and acknowledgment of trending topics, trending debaters, and breaking news in the form of a digital round table discussion. In an exemplary embodiment, this digital production is digitally available to the users as an online show. In embodiments, a weekly 30-minute online show is available to the user(s). In embodiments, the online show is hosted by a panel discussing wide-ranging trending topics from all over the world. In alternative embodiments, the duration of the online show is 10 minutes, 15 minutes, 20 minutes, 25 minutes, 35 minutes, 40 minutes, 45 minutes, 50 minutes, 55 minutes, 1 hour, 1 hour and 15 minutes, 1 hour and 30 minutes, 1 hour and 45 minutes, 2 hours, about 10 minutes, about 15 minutes, about 20 minutes, about 25 minutes, about 30 minutes, about 35 minutes, about 40 minutes, about 45 minutes, about 50 minutes, about 55 minutes, about 1 hour, about 1 hour and 15 minutes, about 1 hour and 30 minutes, about 1 hour and 45 minutes, or about 2 hours. In embodiments, the online show airs daily, twice daily, three times daily, every two weeks, monthly, quarterly, about weekly, about daily, about twice daily, about three times daily, about every two weeks, about monthly, or about quarterly.

In an exemplary embodiment, during a weekly digital broadcast of the online show, a panel of hosts reviews trending topics, debates, debaters, and news from the current week. Viewers will have the means to directly interact with the show hosts to promote deeper discussions and further acknowledgments of various topics. In embodiments, participation of viewers to the online show hosts will be in the form of live commenting similar to how the live commenting is viewable to active debaters and debates on the online debate platform.

In an exemplary embodiment, in addition to the online show, the platform provides breaking news coverage alerts sent to users via push-notifications and/or email. In an embodiment, these digital news broadcasts, known as news blasts, are “bite-sized” instant coverage of breaking news no longer than 40 seconds in length. FIG. 2 illustrates a system diagram for live streaming and video on demand (VOD) broadcasts of the present invention. In alternative embodiments, the duration of the news blasts are 10 seconds, 15 seconds, 20 seconds, 30 seconds, 45 seconds, 1 minute, 1 minute and 15 seconds, 1 minute and 30 seconds, 1 minute and 45 seconds, 2 minutes, about 10 seconds, about 15 seconds, about 20 seconds, about 30 seconds, about 40 seconds, about 45 seconds, about 1 minute, about 1 minute and 15 seconds, about 1 minute and 30 seconds, about 1 minute and 45 seconds, or about 2 minutes.

In an exemplary embodiment, users can opt to have email and/or push notifications for the online show and news blasts, as curated by the online debate platform. This can range from a generic alert or notification for all videos to personalized video topic selections for specific categories and trends.

### AI Monitoring System

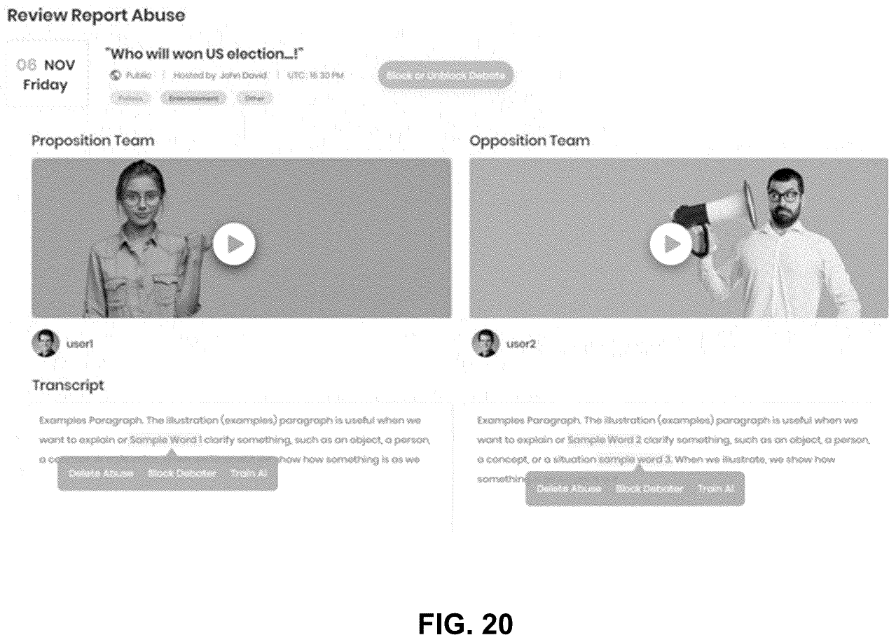

In an exemplary embodiment of the present invention, an AI system of the online debate platform includes a unique internal monitoring algorithm which provides both an online debate platform team and platform user(s) with an instant alert if an offense is “flagged,” an embodiment of which is shown in FIG. 20. In an exemplary embodiment, the AI monitoring system of the present online debate platform offers real-time observation and alerts to both the user(s) and the online debate platform team to monitor and adjust accordingly. FIG. 5 shows a schematic diagram of an embodiment of the AI monitoring system of the present invention. In an exemplary embodiment, the AI monitoring system real-time observation includes monitoring of the audio of live debates and the text in the comments section. As offenses are flagged to the user and sent to the online debate platform team, the support team can either “teach” the AI if the flag is in error to remedy that issue, or it can affirm its flag to be more responsive for future monitoring by adding the flagged language to the obscene and inappropriate language dataset. Integration of this AI monitoring system into the present platform encourages users to stick to the debate topics and subject matter rather than resorting to personal attacks in real time.

In an exemplary embodiment, the AI system is configured with advanced features to allow the system to pinpoint offensive word(s) out of an entire sentence within context and subsequently alert both the user and the online debate platform team. In an exemplary embodiment, the notification to the user and the online debate platform team provides further context as to why a word or sentence was flagged. The user will have the opportunity via the alert to contest the flag if warranted. If the flag or alert is determined to be in error by the support team prior to a contention by the user (or after reviewing the contest), the support team can correct the AI monitoring system and subsequently notify the user of the correction.

In an exemplary embodiment, the AI monitoring system is configured to digitally print out a transcript of the debate in real or near real time, and any obscene or inappropriate language flagged is noted in the transcript. In an exemplary embodiment, whether the flagged language is warranted and affirmed by the support team or determined to be in error, the AI system is configured to review the context of use of such language to continue to learn and adapt for future debate monitoring. In exemplary embodiments, the debate, a participant to the debate whose language was flagged, and/or the user's profile may be blocked or suspended for a period of time following use of obscene or inappropriate language and/or repeated offenses.

In an exemplary embodiment, the AI monitoring system language dataset includes multiple tiers of obscene and inappropriate language. In such an embodiment, the penalty to a user will be greater if the flagged language is part of a more offensive language tier.

In a further exemplary embodiment of the present invention, the AI monitoring system is configured to control a digital “coin-flip” for who goes first in the debates. In embodiments, the AI system controls the microphone of who is actively speaking versus who is not actively speaking. In an exemplary embodiment, a user is required to opt-in to allow the platform AI system to control use of the user's microphone prior to being allowed to participate in debates.

In an exemplary embodiment, the AI system is further configured for displaying a timer within the participants' user interface to show remaining time to debate. In some embodiments, the timer is displayed throughout the entire debate. In other embodiments, the timer is configured to be displayed only with under a certain amount of time remaining. In embodiments, a user can yield remaining time in that user's turn to speak. In some embodiments, yielded time in one segment can be added to a later segment in the debate. In other embodiments, yielded time is merely forfeited.

In embodiments, the AI system is further configured to monitor voting by users in the audience during and after debates to continually affirm and/or change the debate “winner” based upon viewer participation. In embodiments, the AI system curates viewable debate topics based on the user's profile and/or viewing trends. In embodiments, the AI system randomly generates the debate opponent per each platform user when participating in an open instant debate.

### Video Commenting

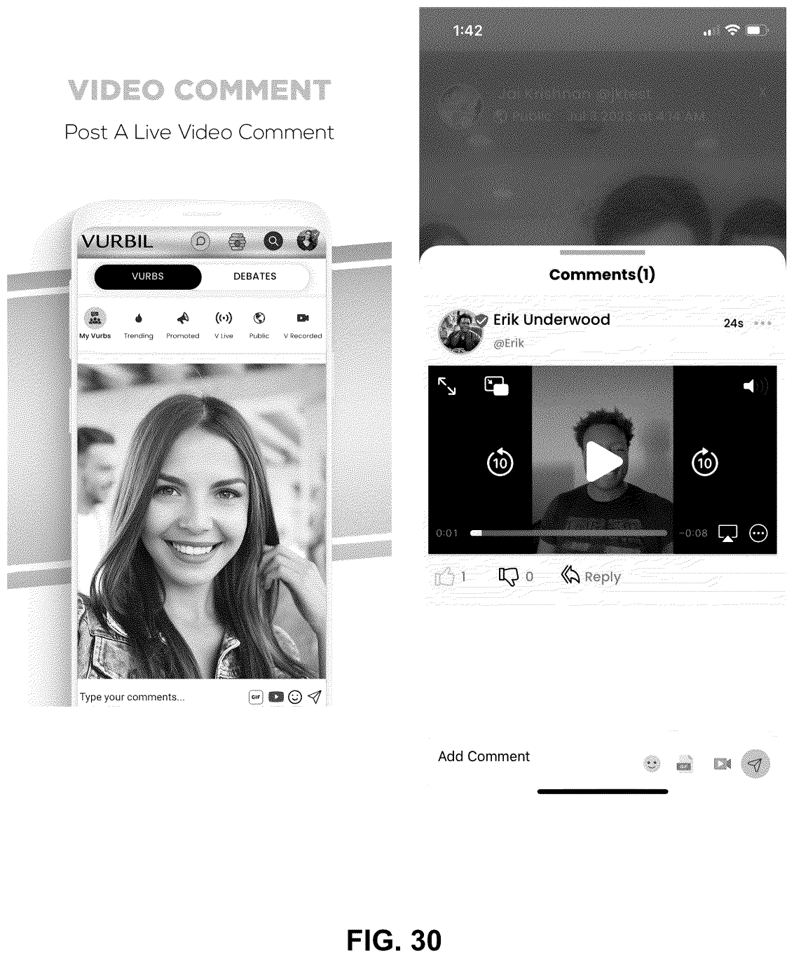

As an improvement to communications on social media, in an exemplary embodiment, the online debate platform allows users the option to instantly record a video directly in the comments section to reply to a post. In an exemplary embodiment, the online debate platform further allows users to video comment in the comments section of an online show to interact with said show. The video comment option allows for direct communication on how a comment is said or intended and helps to eliminate issues relating to misinterpretation of tone, statements taken out of context, or comments otherwise being misinterpreted, as is commonplace on prior art social media platforms. FIGS. 30-32 show exemplary embodiments of video commenting in the comments section.

In an exemplary embodiment, video files recorded via a user's mobile computing device are compressed and/or formatted to be sized with a letter box within the comments section(s) of the online debate platform. In embodiments, the video commenting functionality is configured for adapting to proper sizing for IOS, Android, and web-based user interfaces. In an exemplary embodiment, video comments are configured to be flappable and/or scrollable from video to video posted by a user.

As an improvement to communication, in an exemplary embodiment, the platform allows users to host live broadcasts directly in the comments section to attract a broader discussion around an original debate and/or comment posted. This feature will ensure more voices are heard on hot topic issues especially if the original post was posted by a celebrity or public figure. In an exemplary embodiment, in the event of a live broadcast stream in the comments section, the original poster and every user who commented in and/or engaged with the comment section will be notified.

### Featured Debates

In another exemplary embodiment of the present invention, the online debate platform allows for celebrity and/or high-profile debates where a host user and participant(s) can optionally charge the audience a fee for watching the debate and split revenue from the debate. This feature provides debate content hosts and content creators an avenue to generate revenue for themselves.

### Encrypted Text Chat

In a further exemplary embodiment, the online debate platform includes encrypted text chat functionality between users. Such text chat encryption provides added privacy for users when communicating with other users on the platform.

### Advertisement Customization and Previewing

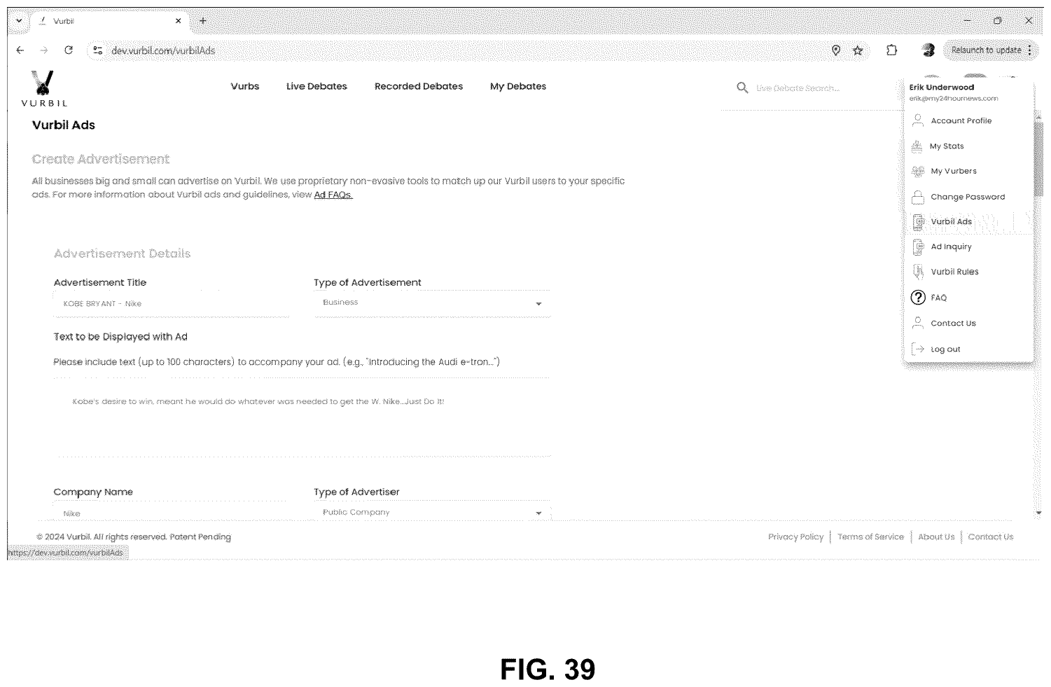

In an exemplary embodiment of the present invention, the system further provides customizable advertising functionality for advertising users. If a party wants to advertise on the present platform, the system is configured to allow such party to create an advertisement from an online form accessible via the user interface. Such online form allows the user to upload content; provide information regarding advertiser; select type(s) of advertisement; select advertisement placement and formatting; select what areas of the online debate platform to advertise in, select target market(s) based on location, areas of interest, hashtags, etc.; among other customization. In an exemplary embodiment, the advertisement creation page on the present platform is configured to provide advertisement preview(s) immediately for an advertiser party to see prior to posting the advertisement. Such advertisement preview functionality provides advertising users much more control and information relating to advertising when compared to prior art digital advertising systems. FIGS. 39-41 show embodiments of a create advertising online form and advertising previews.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive.

Unless defined otherwise, all technical and scientific terms used herein have the same meaning as commonly understood by one of ordinary skill in the art to which this invention belongs. Although any systems, elements, methods, and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices, and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

Various embodiments of a computer program, system, and method of embodiments of the present invention are implemented in hardware, software, firmware, or combinations thereof, which broadly comprises server devices, computing devices, and a communications network. Various embodiments of the server devices include computing devices that provide access to one or more general computing resources, such as internet services, electronic mail services, data transfer services, and the like. In some embodiments the server device(s) also provide access to a database that stores information and data, with such information and data including, without limitation, account information, natural language understanding (NLU) model information, campaign information, personality information, or other information and data necessary and/or desirable for the implementation of the computer program, system, and method of the present invention, as will be discussed in more detail below.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices, and the like, or combinations thereof. Various embodiments of the computing devices also include voice communication devices, such as cell phones or landline phones. In some preferred embodiments, the computing device has an electronic display, such as a cathode ray tube, liquid crystal display, light emitting diode (LED), plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include but are not limited to the internet, an intranet, a local area network, cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments, information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the internet) with the computing device.

An exemplary system for implementing aspects described herein includes a computing device. In its most basic configuration, a computing device of the present invention includes at least one processing unit and memory. Depending on the exact configuration and type of computing device, memory may be volatile (such as random access memory (RAM)), non-volatile (such as read-only memory (ROM), flash memory, etc.), or some combination thereof.

A computing device of the present invention may have additional features and functionality, whether or not explicitly described herein. For example, the computing device may include additional storage (removable and/or non-removable) including, but not limited to, magnetic or optical disks or tape.

The computing device typically includes a variety of tangible computer readable media. Computer readable media can be any available tangible media that can be accessed by device and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory, removable storage, and non-removable storage are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device. Any such computer storage media may be part of the computing device of the present invention.

The computing device may contain communications connection(s) that allow the device to communicate with other devices. The computing device may also have input device(s) such as a keyboard, mouse, pen, voice input device, touch input device, etc. Output device(s) such as a display, speakers, printer, etc. may also be included.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations of the described techniques may include hardware, a method or process, or computer software on a computer-accessible medium.

It will be understood that certain features and subcombinations are of utility and may be employed without reference to other features and subcombinations and are contemplated within the scope of the claims. Not all steps listed in the various figures need be carried out in the specific order described.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is:

1. An online debate system comprising:
a system processor connected to two or more user computing devices via a communications network;
each said user computing device comprising a display;
said system processor further connected to a database comprising a memory;
a user interface accessible on each said user computing device display;
wherein said system processor is configured to facilitate a debate between two or more participants accessible via said user interface;
wherein said system processor is programmed with an artificial intelligence (AI) monitoring system comprising an AI model having speech to text transcription functionality and configured to monitor said debate in real time and to flag instances of inappropriate language;
wherein said AI monitoring system is configured for sending real time notifications relating to flagged language to said participants and to a system support team.

2. The online debate system according to claim 1, wherein:
said AI monitoring system is configured to identify offensive words out of one or more sentences and said notifications are configured to provide context for why language was flagged.

3. The online debate system according to claim 1, wherein:
said user interface is further configured for access by one or more viewer users; and
said user interface is further configured to allow said one or more viewer users to vote on winners of said debate.

4. The online debate system according to claim 3, wherein:
said AI monitoring system is further configured to moderate time to speak for each of said participants, monitor votes from said one or more viewer users, and to continually update a winner of said debate based on said votes.

5. The online debate system according to claim 3, further comprising:
a comments page associated with said debate and accessible by said one or more viewer users via said user interface.

6. The online debate system according to claim 5, wherein:
said comments page is configured to accommodate video comments being posted thereto by said one or more viewer users.

7. The online debate system according to claim 6, wherein:
said system is configured to compress and format said video comments with a letter box within said comments section.

8. The online debate system according to claim 1, further comprising:
an advertisement page accessible by an advertiser user via said user interface; and
said advertisement page comprising a customizable advertisement creation form configured to accommodate input from said advertiser user regarding an advertisement to be created.

9. The online debate system according to claim 8, wherein:
said advertisement page further comprises an advertisement preview configured for displaying a mockup advertisement via said user interface of said advertisement to be created based on input into said customizable advertisement creation form.

10. The online debate system according to claim 1, wherein the user interface further comprises:
a debate creation page for creating said debate;
an instant debate page for joining or creating an instant debate; and
a curated debate page for registering to participate in a curated debate.

11. The online debate system according to claim 1, wherein:
the debate creation page includes fields for inputting debate parameters including said participants, a position for each participant, and a time limit.

12. The online debate system according to claim 1, wherein:
the user interface further comprises a debate video feed including a split screen display showing said participants.

13. The online debate system according to claim 1, wherein:
said AI monitoring system is trained samples of appropriate language and said inappropriate language.

14. The online debate system according to claim 13, wherein:
said AI monitoring system is configured to further train to identify said inappropriate language by continually learning and adapting to new language over time.

15. The online debate system according to claim 13, wherein:
said AI monitoring system is further trained to identify said inappropriate language by manual review and correction by one or more administrative user.

16. The online debate system according to claim 4, wherein:
each said user computing device comprises or is connected to a microphone and a camera.

17. The online debate system according to claim 16, wherein:
said AI monitoring system is configured to mute said microphone on each said user computing device when it is not the time to speak of the participant associated with said muted computing device.

18. A method of facilitating a debate comprising:
providing an online debate system comprising a system processor connected to two or more user computing devices via a communications network; each said user computing device comprising a display; said system processor further connected to a database comprising a memory; a user interface accessible on each said user computing device display; wherein said system processor is configured to facilitate a debate between two or more participants accessible via said user interface; and wherein said system processor is programmed with an artificial intelligence (AI) monitoring system comprising an AI model having speech to text transcription functionality and configured to monitor said debate in real time and to flag instances of inappropriate language;
said AI monitoring system monitoring said debate between a first participant and a second participant in real time and flagging instances of inappropriate language;
said AI monitoring system sending real time notifications relating to flagged language to said first and second participants and to a system support team; and
said AI monitoring system further moderating time to speak for each of said participants.

19. The method of claim 18, further comprising:
one or more viewer users viewing said debate via said user interface; and
said one or more viewer users voting on a winner of said debate.

20. The method of claim 19, further comprising:
said AI monitoring system monitoring votes from said one or more viewer users and continually updating said winner of said debate based on said votes.
